(19) United States
(12) Patent Application Publication
(10) Pub. No.: US 2025/0389440 A1
(43) Pub. Date: Dec. 25, 2025

(54) AIR CONDITIONER INCLUDING PLURALITY OF TEMPERATURE SENSORS AND CONTROLLING METHOD FOR THE AIR CONDITIONER

(71) Applicant: Samsung Electronics Co., Ltd., Suwon-si (KR)

(72) Inventor: Hyoshin LEE, Suwon-si (KR)

(21) Appl. No.: 19/191,720

(22) Filed: Apr. 28, 2025

Related U.S. Application Data
(63) Continuation of application No. PCT/KR2025/099816, filed on Mar. 18, 2025.

(30) Foreign Application Priority Data
Jun. 21, 2024 (KR) 10-2024-0081377

(51) Int. Cl. F24F 11/49; F24F 110/10; F24F 140/20

(52) U.S. Cl. CPC F24F 11/49; F24F 2110/10; F24F 2140/20

(57) ABSTRACT

An air conditioner is provided. The air conditioner includes a first group of a plurality of temperature sensors arranged in a first space, an air conditioning module comprising air conditioning circuitry, memory storing one or more computer programs, and one or more processors communicatively coupled to the first group of the plurality of temperature sensors, the air conditioning module, and the memory, wherein the one or more computer programs include computer-executable instructions that, when executed by the one or more processors individually or collectively, cause the air conditioner to obtain a temperature detection value of each of the plurality of temperature sensors of the first group before the air conditioning module starts an air conditioning operation, determine whether there is a temperature sensor in an abnormal state from among the first group of the plurality of temperature sensors by using the temperature detection value of each of the plurality of temperature sensors of the first group, when it is determined there is the temperature sensor in the abnormal state, correct the temperature detection value of the temperature sensor in the abnormal state to a corrected temperature detection value by using temperature detection values of other temperature sensors not in the abnormal state from among the first group of the plurality of temperature sensors, and control the air conditioning operation of the air conditioning module by using the corrected temperature detection value.

### CROSS-REFERENCE TO RELATED APPLICATION(S)

This application is a continuation application, claiming priority under 35 U.S.C. § 365 (c), of an International application No. PCT/KR2025/099816, filed on Mar. 18, 2025, which is based on and claims the benefit of a Korean patent application number 10-2024-0081377, filed on Jun. 21, 2024, in the Korean Patent Office, the disclosure of which is incorporated by reference herein in its entirety.

### TECHNICAL FIELD

The disclosure relates to an air conditioner including a plurality of temperature sensors, a controlling method for the air conditioner, and a computer-readable recording medium having recorded thereon a program for executing, on a computer, the controlling method for the air conditioner.

### BACKGROUND ART

Various types of air conditioners are widely used in indoor spaces. Air conditioners may include various sensors, such as a human detection sensor, an illumination sensor, a temperature sensor, etc. The air conditioners may recognize, through a temperature sensor, accurate temperature states and changes in a space in which air conditioning is to be performed. Also, for the air conditioners to control inner components, such as a heat exchanger, etc., accurate temperature measurement is necessary. However, when a temperature sensor cannot accurately measure the temperature, due to a breakdown, an assembling defect, etc., the air conditioners may not operate with normal control logic, and thus, air conditioning performance may be degraded and a user may feel inconvenience.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an air conditioner including plurality of temperature sensors and controlling method for the air conditioner.

Additional aspects will be set forth in part in the description which follows and, in part, will be apparent from the description, or may be learned by practice of the presented embodiments.

In accordance with an aspect of the disclosure, an air conditioner is provided. The air conditioner includes a first group of a plurality of temperature sensors arranged in a first space, air conditioning circuitry, memory storing one or more computer programs, and one or more processors communicatively coupled to the first group of the plurality of temperature sensors, the air conditioning module, and the memory, wherein the one or more computer programs include computer-executable instructions that, when executed by the one or more processors individually or collectively, cause the air conditioner to obtain a temperature detection value of each of the plurality of temperature sensors of the first group before the air conditioning circuitry starts an air conditioning operation, determine whether there is a temperature sensor in an abnormal state from among the first group of the plurality of temperature sensors by using the temperature detection value of each of the plurality of temperature sensors of the first group, when it is determined that there is the temperature sensor in the abnormal state, correct the temperature detection value of the temperature sensor in the abnormal state to a corrected temperature detection value by using temperature detection values of other temperature sensors not in the abnormal state from among the first group of the plurality of temperature sensors, and control the air conditioning operation of the air conditioning circuitry by using the corrected temperature detection value.

In accordance with another aspect of the disclosure, a controlling method performed by an air conditioner including temperature sensors is provided. The controlling method includes before air conditioning module of the air conditioner starts an air conditioning operation, obtaining, by the air conditioner, a temperature detection value of each of a first group of a plurality of temperature sensors arranged in a first space, determining, by the air conditioner, whether there is a temperature sensor in an abnormal state from among the first group of the plurality of temperature sensors by using the temperature detection value of each of the plurality of temperature sensors of the first group, based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors, and performing, by the air conditioner, the air conditioning operation by using the corrected temperature detection value.

In accordance with another aspect of the disclosure, one or more non-transitory computer-readable storage media storing one or more computer programs including computer-executable instructions that, when executed by one or more processors of an air conditioner individually or collectively, cause the air conditioner to perform operations are provided. The operations include before air conditioning module of the air conditioner starts an air conditioning operation, obtaining, by the air conditioner, a temperature detection value of each of a first group of a plurality of temperature sensors arranged in a first space, determining, by the air conditioner, whether there is a temperature sensor in an abnormal state from among the first group of the plurality of temperature sensors by using the temperature detection value of each of the plurality of temperature sensors of the first group, based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors, and performing, by the air conditioner, the air conditioning operation by using the corrected temperature detection value.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram showing an operation of an air conditioner, according to an embodiment of the disclosure;

FIG. 2 is a block diagram of a structure of an air conditioner, according to an embodiment of the disclosure;

FIG. 3 is a flowchart of a controlling method for an air conditioner, according to an embodiment of the disclosure;

FIG. 4 is a flowchart of a controlling method for an air conditioner, according to an embodiment of the disclosure;

FIG. 5 is a diagram showing a process of determining whether or not there is a temperature sensor in an abnormal state, according to an embodiment of the disclosure;

FIG. 6 is a diagram showing an example of a process of detecting a temperature sensor in an abnormal state, according to an embodiment of the disclosure;

FIG. 7 is a diagram showing a process of determining an abnormal state of a temperature sensor of an indoor unit, according to an embodiment of the disclosure;

FIG. 8 is a flowchart of a controlling method for an air conditioner, according to an embodiment of the disclosure;

FIG. 9 is a flowchart of a process of calculating a temperature correction parameter and correcting a temperature detection value, according to an embodiment of the disclosure;

FIG. 10 is a diagram showing an example of a process of calculating a temperature correction parameter and correcting a temperature detection value, according to an embodiment of the disclosure;

FIG. 11 is a diagram showing a process of generating an error when a temperature sensor in an abnormal state is detected, according to an embodiment of the disclosure;

FIG. 12 is a diagram showing a temperature change of a temperature sensor in an abnormal state, according to an embodiment of the disclosure;

FIG. 13 is a diagram showing a temperature change of a temperature sensor in an abnormal state, according to an embodiment of the disclosure;

FIG. 14 is a diagram showing an air conditioner, an external device, and a server, according to an embodiment of the disclosure;

FIG. 15 is a block diagram of a structure of an air conditioner, according to an embodiment of the disclosure; and

FIG. 16 is a flowchart of a controlling method for an air conditioner, according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

With regard to the description of the drawings, similar reference numerals may be used for similar or relevant components.

Unless clearly otherwise indicated in context, the singular expressions “a,” “an,” and “the” shall be understood to include a plurality of objects. Thus, for example, the expression “a configuration surface” may also include a case indicating one or more of such surfaces.

In this disclosure, each of expressions such as “A or B,” “at least one of A and B,” “at least one of A or B,” “A, B, or C,” “at least one of A, B, and C,” and “at least one of A, B, or C” may include any one of items listed together with the corresponding expression or all possible combinations of the same.

The expression “and/or” includes a combination of a plurality of described relevant components or any one of the plurality of described relevant components.

Terms such as “1st,” “2nd,” “first,” and “second” may be merely used to distinguish a corresponding component from other corresponding components and do not limit the corresponding components in terms of other aspects (for example, the degree of importance or the order).

When a certain (for example, a first) element is referred to as being “coupled” or “connected” to another (for example, a second) element with the term “functionally” or “communicatively” or without this term, it denotes that the element may be connected to the other element directly (for example, in a wired manner), wirelessly, or through a third element.

The term “including” or “having” is used to indicate a presence of a feature, a number, a step, an operation, an element, a component, or a combination thereof described herein, and the term does not exclude a presence of one or more other features, numbers, steps, operations, elements, components, or a combination thereof or the possibility of an addition of the same.

When a certain element is referred to as being “connected to,” “coupled to,” “supported by,” or “in contact with” another element, it denotes not only the case where the elements are directly connected to, coupled to, supported by, or in contact with each other, but also the case where the elements are indirectly connected to, coupled to, supported by, or in contact with each other through a third element.

When a certain element is referred to as being “above” another element, it includes not only the case where the element is in contact with the other element, but also the case where yet another element is present between the two components.

The combinations of the blocks in each of flowcharts or the flowcharts shall be understood to be performed by one or more computer programs including computer-executable instructions. All of the one or more computer programs may be stored in a single memory or may be separated and stored in a plurality of different memories.

All of the functions or operations described in this disclosure may be processed by one processor or a combination of processors. The one processor or the combination of the processors may refer to circuitry and may include the circuitry, such as an application processor (AP) a communication processor (CP), a graphical processing unit (GPU), a neural processing unit (NPU), a microprocessor unit (MPU), a system on chip (SoC), an integrated chip (IC), etc.

An air conditioner according to an embodiment of the disclosure may be configured to perform the functions of air conditioning, ventilation, humidity control, cooling or heating, etc. in an air conditioning space (hereinafter, referred to as an “indoor space”) and may refer to a device including at least one of these functions.

According to an embodiment of the disclosure, the air conditioner may include a heat pump device configured to perform a cooling function or a heating function. The heat pump device may include a freezing cycle in which a refrigerant circulates along a compressor, a first heat exchanger, an expansion device, and a second heat exchanger. All components of the heat pump device may be embedded in one housing forming the exterior shape of the air conditioner, and a window-type air conditioner or a mobile air conditioner may correspond to this air conditioner. On the contrary, some of the components of the heat pump device may be separately embedded in a plurality of housings forming one air conditioner, and a wall-mounted-type air conditioner, a stand-type air conditioner, a system air conditioner, etc. may correspond to this air conditioner.

The air conditioner including the plurality of housings may include at least one outdoor unit mounted outdoors and at least one indoor unit mounted indoors. For example, an air conditioner may be provided such that one outdoor unit and one indoor unit may be connected to each other through a refrigerant pipe. For example, an air conditioner may be provided such that one outdoor unit may be connected to two or more indoor units through a refrigerant pipe. For example, an air conditioner may be provided such that two or more outdoor units may be connected to two or more indoor units through a plurality of refrigerant pipes.

An outdoor unit may be electrically connected to an indoor unit. For example, information (or a command) to control the air conditioner may be input through an input interface provided in the outdoor unit or the indoor unit, and the outdoor unit and the indoor unit may simultaneously or sequentially operate in response to a user input.

The air conditioner may include an outdoor heat exchanger provided in the outdoor unit, an indoor heat exchanger provided in the indoor unit, and a refrigerant pipe connecting the outdoor heat exchanger with the indoor heat exchanger.

The outdoor heat exchanger may perform a heat exchange between a refrigerant and outdoor air via a phase change (for example, evaporation or condensation) of the refrigerant. For example, while the refrigerant is being condensed in the outdoor heat exchanger, the refrigerant may emit heat to the outdoor air, and while the refrigerant flowing through the outdoor heat exchanger is being evaporated, the refrigerant may absorb heat from the outdoor air.

The indoor unit may be provided indoors. For example, indoor units may be classified into a ceiling-type indoor unit, a stand-type indoor unit, a wall-mounted-type indoor unit, etc., according to an arrangement method. For example, ceiling-type indoor units may be classified into a 4-way-type indoor unit, a 1-way-type indoor unit, a duct-type indoor unit, etc., according to an air discharging method.

Likewise, the indoor heat exchanger may perform a heat exchange between a refrigerant and indoor air via a phase change (for example, evaporation or condensation) of the refrigerant. For example, while the refrigerant is being evaporated in the indoor unit, the refrigerant may absorb heat from the indoor air, and by blowing the indoor air cooled through the cooled indoor heat exchanger, the indoor space may be cooled. For example, while the refrigerant is being condensed in the indoor heat exchanger, the refrigerant may emit heat to the indoor air, and by blowing the indoor air heated through the indoor heat exchanger having a high temperature, the indoor space may be heated.

That is, the air conditioner may perform the function of cooling or heating through a phase change process of the refrigerant circulating through the outdoor heat exchanger and the indoor heat exchanger. For this circulation of the refrigerant, the air conditioner may include a compressor compressing the refrigerant. The compressor may suck in a refrigerant gas through a suction portion and compress the refrigerant gas. The compressor may discharge the refrigerant gas having high temperature and high pressure through a discharge portion. The compressor may be arranged in the outdoor unit.

The refrigerant may, through the refrigerant pipe, circulate sequentially through the compressor, the outdoor heat exchanger, the expansion device, and the indoor heat exchanger, or circulate sequentially through the compressor, the indoor heat exchanger, the expansion device, and the outdoor heat exchanger.

For example, when one outdoor unit is directly connected to one indoor unit through a refrigerant pipe in the air conditioner, the refrigerant may be provided to circulate between the one outdoor unit and the one indoor unit through the refrigerant pipe.

For example, when one outdoor unit is connected to two or more indoor units through a refrigerant pipe, the refrigerant may flow to the plurality of indoor units through the refrigerant pipe diverged from the outdoor unit. Refrigerants discharged from the plurality of indoor units may be joined and may circulate through the outdoor unit. For example, the plurality of indoor units may be directly connected to one outdoor unit in parallel with each other through separate refrigerant pipes, respectively.

Each of the plurality of indoor units may separately operate according to an operation mode set by a user. That is, some of the plurality of indoor units may operate in a cooling mode, and the others may simultaneously operate in a heating mode. Here, the refrigerant, in a high pressure state or a low pressure state, selectively, may be introduced into each indoor unit and may be discharged from each indoor unit to circulate through the outdoor unit, along a circulation path set by a fluid passage switch valve to be described below.

For example, when two or more outdoor units are connected to two or more indoor units in the air conditioner through a plurality of refrigerant pipes, the refrigerants discharged from the plurality of outdoor units may be joined to flow through one refrigerant pipe, and then, may be diverged again at one point and introduced into the plurality of indoor units.

All of the plurality of outdoor units may be driven or at least some of the plurality of outdoor units may not be driven, according to a driving load based on a driving amount of the plurality of indoor units. Here, the refrigerant may circulate by being introduced into the outdoor unit selectively driven through the fluid passage switch valve. The air conditioner may include the expansion device configured to decrease the pressure of the refrigerant introduced into the heat exchanger. For example, the expansion device may be arranged in the indoor unit or the outdoor unit or may be arranged in both of the indoor unit and the outdoor unit.

The expansion device may be configured to decrease the temperature and the pressure of the refrigerant by using a throttle effect, for example. The expansion device may include an orifice for reducing a cross-sectional area of the fluid passage. The refrigerant having passed through the orifice may have reduced temperature and pressure.

The expansion device may be realized, for example, as an electronic expansion valve which may control an open ratio (a ratio of the cross-sectional area of the fluid passage of the valve in a partially open state to the cross-sectional area of the fluid passage of the valve in a completely open state). Depending on the open ratio of the electronic expansion valve, the amount of the refrigerant passing through the expansion device may be controlled.

The air conditioner may further include the fluid passage switch valve arranged on a refrigerant circulation path. The fluid passage switch valve may include, for example, a 4-way valve. The fluid passage switch valve may determine the circulation path of the refrigerant depending on an operation mode (for example, a cooling operation or a heating operation) of the indoor unit. The fluid passage switch valve may be connected to a discharge portion of the compressor.

The air conditioner may include an accumulator. The accumulator may be connected to a suction portion of the compressor. A low temperature/low pressure refrigerant evaporated from the indoor heat exchanger or the outdoor heat exchanger may be introduced into the accumulator.

The accumulator may separate a refrigerant liquid from the refrigerant gas when the refrigerant in which the refrigerant liquid and the refrigerant gas are mixed is introduced into the accumulator and may provide the refrigerant gas from which the refrigerant liquid is separated to the compressor.

An outdoor fan may be provided in the vicinity of the outdoor heat exchanger. The outdoor fan may blow the outdoor air to the outdoor heat exchanger to facilitate a heat exchange between the refrigerant and the outdoor air.

The outdoor unit of the air conditioner may include at least one sensor. For example, the sensor of the outdoor unit may be provided as an environment sensor. The outdoor unit sensor may be arranged at an arbitrary position inside or outside the outdoor unit. For example, the outdoor unit sensor may include, for example, a temperature sensor configured to sense air temperature around the outdoor unit, a humidity sensor configured to sense air humidity around the outdoor unit, a refrigerant temperature sensor configured to sense a refrigerant temperature of a refrigerant pipe passing through the outdoor unit, or a refrigerant pressure sensor configured to sense refrigerant pressure of the refrigerant pipe passing through the outdoor unit.

The outdoor unit of the air conditioner may include an outdoor unit communicator. The outdoor unit communicator may be provided to receive a control signal from a controller of the indoor unit of the air conditioner, to be described below. The outdoor unit may control an operation of the compressor, the outdoor heat exchanger, the expansion device, the fluid passage switch valve, the accumulator, or the outdoor fan, based on the control signal received through the outdoor unit communicator. The outdoor unit may transmit a sensing value detected from the outdoor unit sensor to the controller of the indoor unit through the outdoor unit communicator.

The indoor unit of the air conditioner may include a housing, an air blower configured to circulate air to the inside or outside of the housing, and the indoor heat exchanger configured to exchange heat with the air introduced into the housing.

The housing may include an inlet. Indoor air may be introduced into the housing through the inlet.

The indoor unit of the air conditioner may include a filter provided to filter out impurities of the air introduced into the housing through the inlet.

The housing may include an outlet. Air moving in the housing may be discharged to the outside of the housing through the outlet.

An air current guide configured to guide a direction of the air discharged through the outlet may be provided in the housing of the indoor unit. For example, the air current guide may include a blade positioned above the outlet. For example, the air current guide may include an auxiliary fan configured to adjust a discharge air current. The disclosure is not limited thereto, and the air current guide may be omitted.

The indoor heat exchanger and the air blower arranged on a path connecting the inlet to the outlet may be provided in the housing of the indoor unit.

The air blower may include an indoor fan and a fan motor. For example, the indoor fan may include an axial fan, a diagonal fan, a cross flow fan, and a centrifugal fan.

The indoor heat exchanger may be arranged between the air blower and the outlet or between the inlet and the air blower. The indoor heat exchanger may absorb heat from the air introduced through the inlet or transmit heat to the air introduced through the inlet. The indoor heat exchanger may include a heat exchange pipe in which a refrigerant flows and a heat exchange pin in contact with the heat exchange pipe to increase a heating surface.

The indoor unit of the air conditioner may include a drain tray arranged below the indoor heat exchanger and collecting condensate water generated in the indoor heat exchanger. The condensate water accommodated in the drain tray may be discharged to the outside through a discharge hose. The drain tray may be provided to support the indoor heat exchanger.

The indoor unit of the air conditioner may include an input interface. The input interface may include an arbitrary type of user input device including a button, a switch, a touch screen, and/or a touch pad. A user may directly input setting data (for example, a desired indoor temperature, cooling/heating/dehumidification/air cleaning operation mode setting, outlet selection setting, and/or wind intensity setting) through the input interface.

The input interface may also be connected to an external input device. For example, the input interface may be electrically connected to a wired remote controller. The wired remote controller may be mounted on a certain position (e.g., a portion of a wall surface) in an indoor space. The user may input the setting data with respect to an operation of the air conditioner by manipulating the wired remote controller. An electrical signal corresponding to the setting data obtained through the wired remote controller may be transmitted to the input interface. Also, the input interface may include an infrared sensor. The user may remotely input the setting data with respect to an operation of the air conditioner by using a wireless remote controller. The setting data input through the wireless remote controller may be transmitted to the input interface as an infrared signal.

Also, the input interface may include a microphone. A voice command of the user may be obtained through the microphone. The microphone may convert the voice command of the user into an electrical signal and may transmit the converted electrical signal to the indoor unit controller. The indoor unit controller may control components of the air conditioner to perform a function corresponding to the user's voice command. The setting data (for example, the desired indoor temperature, the cooling/heating/dehumidification/air cleaning operation mode setting, the outlet selection setting, and/or the wind intensity setting) obtained through the input interface may be transmitted to the indoor unit controller described below. For example, the setting data obtained through the input interface may be transmitted to the outside, that is, to the outdoor unit or a server, through an indoor unit communicator to be described below.

The indoor unit of the air conditioner may include a power module. The power module may be connected to an external power supply and may supply power to the components of the indoor unit.

The indoor unit of the air conditioner may include an indoor unit sensor. The indoor unit sensor may include an environment sensor arranged inside or outside the housing. For example, the indoor unit sensor may include one or more temperature sensors and/or humidity sensors arranged in (a) predetermined space(s) inside or outside the housing of the indoor unit. For example, the indoor unit sensor may include a refrigerant temperature sensor configured to sense a refrigerant temperature of the refrigerant pipe passing through the indoor unit. For example, the indoor unit sensor may include refrigerant temperature sensors respectively configured to sense temperatures of an inlet, an intermediate portion, and/or an outlet of the refrigerant pipe passing through the indoor heat exchanger.

For example, each piece of environment information sensed by the indoor unit sensor may be transmitted to the indoor unit controller described below, or to the outside through the indoor unit communicator to be described below.

The indoor unit of the air conditioner may include the indoor unit communicator. The indoor unit communicator may include at least one of a short-range wireless communication module or a remote communication module. The indoor unit communicator may include at least one antenna for wirelessly communicating with another device. The outdoor unit may include the outdoor unit communicator. The outdoor unit communicator may include at least one of a short-range wireless communication module or a remote communication module.

The short-range wireless communication module may include a Bluetooth™ communication module, a Bluetooth™ low energy (BLE) communication module, a near-field communication (NFC) module, a wireless local area network (WLAN) (or wireless fidelity (Wi-Fi™)) communication module, a Zigbee communication module, an infrared data association (IrDA) communication module, a Wi-Fi™ direct (WFD) communication module, an ultra-wideband (UWB) communication module, an Ant+ communication module, a microwave (uWave) communication module, etc., but is not limited thereto.

The remote communication module may include communication modules configured to perform various types of remote communication and may include a mobile communicator. The mobile communicator may transceive a wireless signal with at least one of a base station, an external terminal, or a server on a mobile communication network.

The indoor unit communicator may communicate with an external device, such as a server, a mobile device, another home appliance device, etc., through a peripheral access point (AP). The AP may connect a local area network (LAN), to which the air conditioner or a user device is connected, to a wide area network (WAN), to which a server is connected. The air conditioner or the user device may be connected to the server through the WAN. The indoor unit of the air conditioner may include the indoor unit controller configured to control the components of the indoor unit including the air blower, etc. The outdoor unit of the air conditioner may include an outdoor unit controller configured to control the components of the outdoor unit including the compressor, etc. The indoor unit controller may communicate with the outdoor unit controller through the indoor unit communicator and the outdoor unit communicator. The outdoor unit communicator may transmit a control signal generated by the outdoor unit controller to the indoor unit communicator or may transmit a control signal transmitted from the indoor unit communicator to the outdoor unit controller. That is, the outdoor unit and the indoor unit may perform bidirectional communication. The outdoor unit and the indoor unit may transmit and receive various signals generated during the operation of the air conditioner.

The outdoor unit controller may be electrically connected to the components of the outdoor unit and may be configured to control an operation of each component. For example, the outdoor unit controller may adjust a frequency of the compressor and control the fluid passage switch valve to switch a circulation direction of the refrigerant. The outdoor unit controller may adjust a rotational speed of the outdoor fan. Also, the outdoor unit controller may generate a control signal to adjust the open rate of an expansion valve. Under control by the outdoor unit controller, the refrigerant may circulate along the refrigerant circulation circuit including the compressor, the fluid passage switch valve, the outdoor heat exchanger, the expansion valve, and the indoor heat exchanger.

Various temperature sensors included in the outdoor unit and the indoor unit may transmit electrical signals corresponding to the temperatures respectively sensed by the temperature sensors to the outdoor unit controller and/or the indoor unit controller. For example, the humidity sensors included in the outdoor unit and the indoor unit may transmit the electrical signals corresponding to the humidity values respectively sensed by the humidity sensors to the outdoor unit controller and/or the indoor unit controller.

The indoor unit controller may obtain a user input from a user device including a mobile device, etc. through the indoor unit communicator and may directly obtain the user input through an input interface or may obtain the user input through a remote controller. The indoor unit controller may control the components of the indoor unit including the air blower, etc. in response to the received user input. The indoor unit controller may transmit information with respect to the received user input to the outdoor unit controller of the outdoor unit.

The outdoor unit controller may control the components of the outdoor unit including the compressor, etc. based on the information with respect to the user input received from the indoor unit. For example, when the outdoor unit controller receives, from the indoor unit, a control signal corresponding to a user input of selecting an operation mode, such as a cooling operation, a heating operation, an air blowing operation, a defrosting operation, or a dehumidification operation, the outdoor unit controller may control the components of the outdoor unit to perform an operation of the air conditioner corresponding to the selected operation mode.

Each of the outdoor unit controller and the indoor unit controller may include a processor and memory. The indoor unit controller may include at least one first processor and at least one first memory, and the outdoor unit controller may include at least one second processor and at least one second memory.

The memory may recall/store various information required for the operations of the air conditioner. The memory may store an instruction, an application, data, and/or a program required for the operations of the air conditioner. For example, the memory may store various programs for a cooling operation, a heating operation, a dehumidification operation, and/or a defrosting operation of the air conditioner. The memory may include volatile memory temporarily recalling data, such as static random-access memory (SRAM) or dynamic random-access memory (DRAM). Also, the memory may include non-volatile memory storing data for a long term, such as read-only memory (ROM), erasable programmable read-only memory (EPROM), or electrically erasable programmable read-only memory (EEPROM).

The processor may generate a control signal to control the operations of the air conditioner based on the instruction, the application, the data, and/or the program stored in the memory. The processor may include hardware, for example, a logic circuit and an operation circuit. The processor may process data according to the program and/or the instruction provided from the memory and may generate the control signal according to a result of the processing. The memory and the processor may be realized as one control circuit or a plurality of circuits.

The processor may include various processing circuits and/or a plurality of processors. For example, the term “processor” used herein including the claims may include various processing circuits including at least one processor. One or more processors of the plurality of processors may be configured to perform various functions described herein separately in a distributed fashion and/or collectively. As used herein, the “processor, the “at least one processor,” and the “one or more processors” may be configured to perform various functions. However, these terms may, without limit, cover a situation in which one processor may perform some of functions and (an) other processor(s) may perform others of the functions and a situation in which a single processor may perform all functions. Also, the at least one processor may include a combination of processors configured to perform, in a distributed fashion, various functions included in the described functions. The at least one processor may execute program instructions to achieve or perform various functions.

The indoor unit of the air conditioner may include an output interface. The output interface may be electrically connected to the indoor unit controller and may output information related to the operations of the air conditioner under control by the indoor unit controller. For example, the information, such as the operation mode, the wind direction, the wind intensity, and the temperature selected by the user input, may be output. Also, the output interface may output sensing information or a warning/error message obtained from the indoor unit sensor or the outdoor unit sensor.

The output interface may include a display and a speaker. The speaker may output various sounds as a sound device. The display may display information input by the user or information provided to the user as various graphic elements. For example, the operation information of the air conditioner may be displayed as at least one of an image or text. Also, the display may include an indicator providing certain information. The display may include a liquid crystal display (LCD) panel, a light-emitting diode (LED) panel, an organic light-emitting diode (OLED) panel, a micro-LED panel, and/or a plurality of LEDs.

Hereinafter, an air conditioner according to various embodiments of the disclosure is described in detail with reference to the drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi™ chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

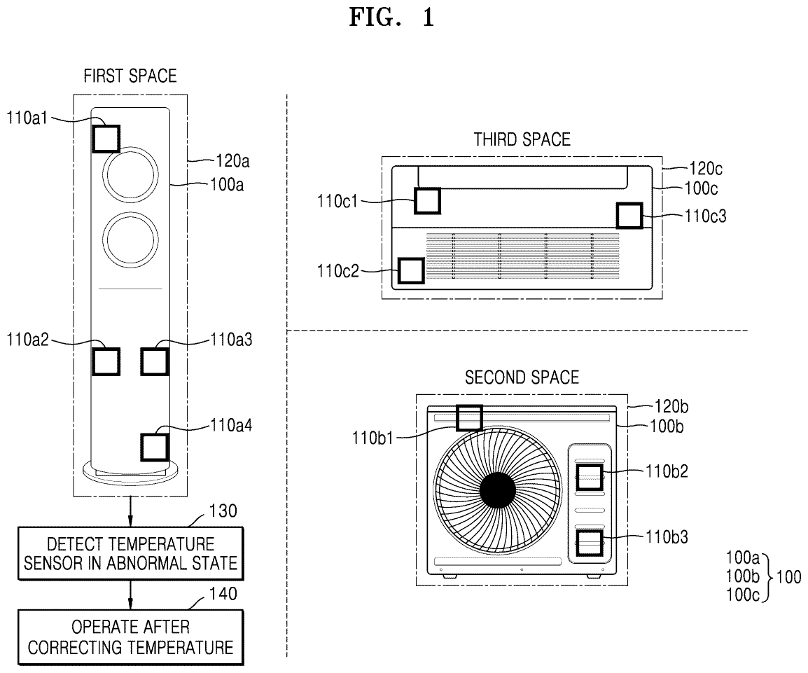

FIG. 1 is a diagram showing an operation of an air conditioner according to an embodiment of the disclosure.

Referring to FIG. 1, according to an embodiment of the disclosure, an air conditioner 100 may perform an air conditioning operation on an object space. The air conditioning operation may include, for example, a cooling, heating, air cleaning, dehumidification, or air blowing operation. The air conditioner 100 may be realized as a cooler, a heater, a cooler and heater, an air cleaner, a dehumidifier, or the like. In the disclosure, a case where the air conditioner 100 corresponds to a cooler is mainly described. However, it is for convenience of explanation, and an embodiment of the disclosure is not limited thereto.

According to an embodiment of the disclosure, the air conditioner 100 may include one or more indoor units 100a and 100c, and an outdoor unit 100b. The one or more indoor units 100a and 100c may be realized as various types including a stand-type, a wall-mounted-type, a system air conditioner, etc. The one or more indoor units 100a and 100c, and the outdoor unit 100b may be arranged in separate spaces from one another. For example, indoor unit 100a may be arranged in a living room, indoor unit 100c may be arranged in a bedroom, and the outdoor unit 100b may be arranged in an outdoor unit room.

Each of the one or more indoor units 100a and 100c, and the outdoor unit 100b of the air conditioner 100 may correspond to a different space. For example, the space in or around the indoor unit 100a may correspond to a first space 120a, the space in or around the indoor unit 100c may correspond to a third space 120c, and the space in or around the outdoor unit 100b may be defined as a second space 120b. Each of the first space 120a, the second space 120b, and the third space 120c may have a similar temperature in a natural state before an air conditioning operation is performed. However, after the air conditioning operation is performed, temperatures in each of the first to third spaces (e.g., first space 120a, second space 120b, and third space 120c) may vary according to positions, as components of each of the indoor unit 100a, indoor unit 100c, and the outdoor unit 100b may operate. For example, when the air conditioning operation is started, an evaporator inlet temperature, an evaporator outlet temperature, and an outlet temperature may become different from each other in the first space 120a corresponding to the indoor unit 100a.

According to an embodiment of the disclosure, each of the indoor unit 100a, the indoor unit 100c, and the outdoor unit 100b may have a plurality of temperature sensors 110. For example, the indoor unit 100a may include a first group of a plurality of temperature sensors 110a1, 110a2, 110a3, and 110a4. The outdoor unit 100b may include a second group of a plurality of temperature sensors 110b1, 110b2, and 110b3. The indoor unit 100c may include a third group of a plurality of temperature sensors 110c1, 110c2, and 110c3. In this disclosure, the temperature sensors 110a1, 110a2, 110a3, 110a4, 110b1, 110b2, 110b3, 110c1, 110c2, and 110c3 are commonly referred to by the reference numeral 110.

Each of the plurality of temperature sensors 110 may be arranged in a different position in each space. For example, the plurality of temperature sensors 110a1, 110a2, 110a3, and 1104 of the first group may be arranged at a housing wall surface, an evaporator inlet, an evaporator outlet, and an outlet, respectively. The first group of the plurality of temperature sensors 110a1, 110a2, 110a3, and 110a4 may separately measure temperatures in their positions in the first space 120a. The first group of the plurality of temperature sensors 110a1, 110a2, 110a3, and 110a4 may measure the temperatures of the first space 120a in a natural state, and thus, may output similar temperature values as one another, before an air conditioning operation. However, after the air conditioning operation is started, temperature patterns of the housing wall surface, the evaporator inlet, the evaporator outlet, and the outlet may become different from one another, and thus, temperature detection values of the plurality of temperature sensors 110a1, 110a2, 110a3, 110a4 may become different from one another.

According to an embodiment of the disclosure, the air conditioner 100 may detect whether or not there is a temperature sensor 110 in an abnormal state from among the plurality of temperature sensors 110 of the same group arranged in the same space. The plurality of temperature sensors 110 of the same group may indicate similar temperatures before an air conditioning operation. However, when there is a temperature sensor 110 having a temperature detection value which is different from temperature detection values of other temperature sensors 110 by a certain value or greater, before the air conditioning operation is started, the corresponding temperature sensor 110 may be in an abnormal state. When the air conditioner 100 detects, before the air conditioning operation, the temperature sensor 110 from among the plurality of temperature sensors 110 of the same group, the temperature sensor 110 having the temperature detection value different from the temperature detection values of the other temperature sensors 110 by the certain value or greater, the air conditioner 100 may determine the temperature sensor 110 having the different temperature detection value as the temperature sensor 110 in the abnormal state, in operation 130.

When the air conditioner 100 detects the temperature sensor 110 in the abnormal state, the air conditioner 100 may correct the temperature detection value of the temperature sensor 110 in the abnormal state and may perform the air conditioning operation by using the corrected temperature detection value, in operation 140.

When the temperature sensor 110 does not output a temperature detection value, the air conditioner 100 may generate a normal error and may not start the air conditioning operation or may stop the air conditioning operation. For example, when a short circuit or an open circuit occurs in the temperature sensor 110 or a connector of the temperature sensor 110 is released, a normal error may be generated. However, when the temperature sensor 110 outputs a temperature detection value, the air conditioner 100 may not generate an error and may perform the air conditioning operation by using the temperature detection value, even when the temperature detection value of the temperature sensor 110 has an abnormal value. However, in this case, the air conditioner 100 may perform the air conditioning operation by using the wrong temperature detection value, and thus, the air conditioning operation may not be properly performed and a user may experience inconvenience. For example, when the temperature sensor 110 outputs a temperature detection value that is higher than an actual value, the air conditioner 100 may perform an excessive cooling operation. Also, for example, when the temperature sensor 110 outputs a temperature detection value that is lower than an actual value, the air conditioner 100 may not start a cooling operation and may operate in an air blowing mode, and thus, the cooling operation for a desired temperature may not be performed.

According to an embodiment of the disclosure, even when the normal error is not generated, the air conditioner 100 may detect the temperature sensor 110 in the abnormal state based on the temperature detection values of the plurality of temperature sensors 110. Also, even when there is the temperature sensor 110 in the abnormal state, the air conditioner 100 may perform a normal air conditioning operation, by performing the air conditioning operation by correcting the temperature detection value of the temperature sensor 110 in the abnormal state.

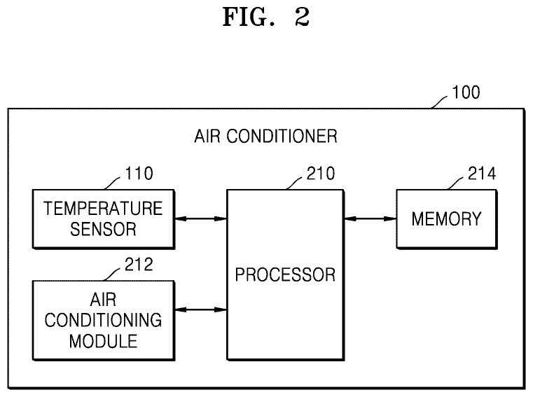

FIG. 2 is a block diagram of a structure of an air conditioner according to an embodiment of the disclosure.

Referring to FIG. 2, an air conditioner 100 may include a plurality of temperature sensors 110, a processor 210, an air conditioning module 212, and memory 214.

The air conditioner 100 may be realized to have various mounted forms. For example, the air conditioner 100 may be realized as a stand type, a wall-mounted type, a ceiling-mounted system air conditioner, or a home multi-air conditioner.

The temperature sensors 110 may be configured to sense temperatures and may be arranged in each of the indoor unit 100a and indoor unit 100c or the outdoor unit 100b of the air conditioner 100. The temperature sensors 110 may measure temperatures as resistance values are changed according to the temperatures. For example, the temperature sensors 110 may include a negative temperature coefficient (NTC) thermistor. The temperature sensors 110 may include a circuit including a resistor.

The air conditioner 100 may include the plurality of temperature sensors 110. The air conditioner 100 may include three or more temperature sensors 110. The three or more temperature sensors 110 may be arranged at different points from one another. The plurality of temperature sensors 110 arranged in the same space may be defined as the temperature sensors 110 of the same group. For example, the temperature sensors 110a1, 110a2, 110a3, and 110a4 arranged in the first space 120a may be defined as the first group of the temperature sensors 110. Also, the temperature sensors 110b1, 110b2, and 110b3 arranged in the second space 120b may be defined as the second group of the temperature sensors 110. The temperature sensors 110c1, 110c2, and 110c3 arranged in the third space 120c may be defined as the third group of the temperature sensors 110.

According to an embodiment of the disclosure, the first group of the temperature sensors 110 arranged in the indoor unit 100a may include at least three temperature sensors 110 from among a room temperature sensor, an evaporator inlet temperature sensor, an evaporator outlet temperature sensor, and an outlet temperature sensor.

The room temperature sensor may be configured to measure the temperature in the housing of the indoor unit 100a. The room temperature sensor may be arranged around an air inlet sucking in external air in the indoor unit 100a. The indoor unit 100a may include the air inlet for sucking in external air. The air of an object space in which the indoor unit 100a is arranged may be sucked into the indoor unit 100a through the air inlet. The room temperature sensor may measure the temperature of the air sucked in, and thus, may measure the indoor temperature of the space in which the indoor unit 100a is arranged.

The evaporator inlet temperature sensor may be configured to measure the temperature of an inlet of an evaporator. The evaporator outlet temperature sensor may be configured to measure the temperature of an outlet of the evaporator. The indoor unit 100a may include the evaporator configured to convert a refrigerant into gas. The evaporator may include an evaporator inlet into which a liquid refrigerant is input and an evaporator outlet from which a gas refrigerant is discharged. The evaporator inlet temperature sensor may be arranged around the evaporator inlet and may measure the temperature of the evaporator inlet. The evaporator outlet temperature sensor may be arranged around the evaporator outlet and may measure the temperature of the evaporator outlet.

The outlet temperature sensor may be configured to measure the temperature of an outlet. The indoor unit 100a may include the outlet through which air is discharged. The outlet may discharge cooled or heated air to an object space. The indoor unit 100a may discharge the air through the outlet through an air blowing fan. The outlet may be provided between a front housing and the air blowing fan. The outlet temperature sensor may be arranged around the outlet.

According to an embodiment of the disclosure, the second group of the temperature sensors 110 arranged in the outdoor unit 100b may include at least three temperature sensors 110 from among a room temperature sensor, a compressor outlet temperature sensor, a compressor top temperature sensor, and a condenser outlet temperature sensor.

The room temperature sensor may be arranged around an air inlet sucking in external air in the outdoor unit 100b. The outdoor unit 100b may include the air inlet for sucking in external air. The air of the space in which the outdoor unit 100b is arranged may be sucked into the outdoor unit 100b through the air inlet. The room temperature sensor may measure the temperature of the air that is sucked in, and thus, may measure the temperature of the space in which the outdoor unit 100b is arranged.

The compressor outlet temperature sensor may be configured to measure the temperature of an outlet of a compressor. The compressor top temperature sensor may be configured to measure the temperature of an inlet of the compressor. The outdoor unit 100b may include the compressor configured to convert a gas refrigerant to a high pressure gas. The compressor may include a compressor top into which the gas refrigerant is input and a compressor outlet through which the high pressure gas is discharged. The compressor outlet temperature sensor may be arranged around the compressor outlet and may measure the temperature of the high pressure gas discharged from the compressor. The compressor top temperature sensor may be arranged around the compressor top and may measure the temperature of the gas refrigerant input into the compressor.

The condenser outlet temperature sensor may be configured to measure the temperature of an outlet of a condenser. The outdoor unit 100b may include the condenser configured to discharge heat from the high temperature and high pressure refrigerant discharged from the compressor. The condenser may include a condenser outlet through which the refrigerant, from which the heat is discharged, is discharged. The condenser outlet temperature sensor may be arranged around the condenser outlet and may measure the temperature of the refrigerant discharged from the condenser.

The processor 210 may control the overall operations of the air conditioner 100. The processor 210 may be realized as one or more processors. The one or more processors included in the processor 210 may include circuitry, such as an SoC, an IC, etc. The processor 210 may perform a certain operation by executing an instruction or a command stored in the memory 214. Also, the processor 210 may control operations of components included in the air conditioner 100. The one or more processors included in the processor 220 may include a general-purpose processor, such as a central processing unit (CPU), a microprocessor unit (MPU), an application processor (AP), a digital signal processor (DSP), etc., a graphics-dedicated processor, such as a graphics processing unit (GPU) and a vision processing unit (VPU), an artificial intelligence (AI)-dedicated processor, such as a neural processing unit (NPU), or a communication-dedicated processor, such as a communication processor (CP). When the one or more processors included in the processor 210 are AI-dedicated processors, the AI-dedicated processors may be designed to have hardware structures specialized for processing specific AI models.

The processor 210 may write data in the memory 214 or read data stored in the memory 214, and particularly, may process data according to a pre-defined operation rule or AI model by executing a program or at least one instruction stored in the memory 214. Thus, the processor 210 may perform operations described in the embodiments of the disclosure described hereinafter. Also, according to the embodiments of the disclosure described hereinafter, the operations described as being performed by the air conditioner 100 or specific components included in the air conditioner 100 may be understood as being performed by the processor 210, unless specifically described.

The processor 210 may receive a temperature detection value from each of the plurality of temperature sensors 110. The processor 210 may identify a current temperature and control an air conditioning operation of the air conditioning module 212, by using the temperature detection value of each temperature sensor 110.

According to an embodiment of the disclosure, when power of the air conditioner 100 is turned on, the processor 210 may obtain the temperature detection value from each of the plurality of temperature sensors 110, before the air conditioning operation of the air conditioning module 212 is started. The processor 210 may determine whether or not there is a temperature sensor 110 in an abnormal state by using the temperature detection values of the temperature sensors 110 of the same group, obtained before the air conditioning operation is started. For example, when a temperature sensor 110 having a temperature detection value which is different from temperature detection values of other temperature sensors 110 of the same group by a first reference value or greater, is detected from among the temperature sensors 110 of the same group, the processor 210 may determine the temperature sensor 110 having the different temperature detection value as the temperature sensor 110 in the abnormal state.

A time point before the air conditioning operation is started may correspond to a time point before a compressor operation of the air conditioning module 212 is started. The compressor may be arranged in a heat pump device of the outdoor unit 100b. After the air conditioner 100 is turned on, the processor 210 may obtain the temperature detection value of each of the plurality of temperature sensors 110 before the compressor operation is started. According to an embodiment of the disclosure, after the air conditioner 100 is turned on, the processor 210 may start the compressor operation after the processor 210 finishes obtaining the temperature detection value of each of the plurality of temperature sensors. When the temperature sensor 110 in the abnormal state is detected before the compressor operation, the processor 210 may, after the compressor operation, correct the temperature detection value of the temperature sensor 110 in the abnormal state by using a temperature correction parameter calculated by using the temperature detection value obtained before the compressor operation, and may control the air conditioning operation by using the corrected temperature detection value.

The temperature detection value of each of the plurality of temperature sensors 110 before the air conditioning operation is started may indicate a temperature in a natural state in or around each separate device (e.g., the indoor unit 100a, the indoor unit 100c, or the outdoor unit 100b.) Thus, when the temperature sensors 110 are in a normal state, the temperature detection values of the temperature sensors 110 of the same group may be similar as one another. However, when the temperature sensors 110 are in an abnormal state, the temperature detection values of the temperature sensors 110 of the same group may, in a natural state, become different from one another. According to an embodiment of the disclosure, the air conditioner 100 may detect the temperature sensor 110 in the abnormal state, which outputs the temperature detection value, but outputs an invalid temperature detection value due to abnormality of the temperature sensor 110. According to the disclosure, a normal state may denote a state of the temperature sensor 110 that does not correspond to the abnormal state.

When the temperature sensor 110 in the abnormal state is detected, the processor 210 may correct the temperature detection value of the temperature sensor 110 in the abnormal state. The processor 210 may correct the temperature detection value of the temperature sensor 110 in the abnormal state by using the temperature detection values of the temperature sensors 110 of the same group. According to an embodiment of the disclosure, the processor 210 may calculate an average of the temperature detection values of two or more temperature sensors 110 of the same group except for the temperature sensor 110 in the abnormal state and may calculate the difference between the average value and the temperature detection value of the temperature sensor 110 in the abnormal state. The processor 210 may define the difference between the average value and the temperature detection value as the temperature correction parameter and may correct the temperature detection value of the temperature sensor 110 in the abnormal state by applying the temperature correction parameter to the temperature detection value of the temperature sensor 110 in the abnormal state. For example, the temperature correction parameter may be a value obtained by subtracting the average value from the temperature detection value of the temperature sensor 110 in the abnormal state, and the processor 210 may define the value obtained by subtracting the temperature correction parameter from the temperature detection value of the temperature sensor 110 in the abnormal state as the corrected temperature detection value.

The air conditioning module 212 may perform the air conditioning operation. The air conditioning module 212 may control whether or not to perform a cooling operation, a cooling intensity, whether or not to perform a heating operation, a heating intensity, a wind intensity, a wind direction, etc. based on a control signal or a driving signal input from the processor 210. The air conditioning module 212 may include a heat exchanger, a motor, an inverter, a fan, a filter, an air current guide, a wind door, etc. The air conditioning module 212 may include the heat exchanger and may perform a heat exchange between a refrigerant and indoor air by using a phase change (for example, expansion or compression) of the refrigerant of the heat exchanger. For example, while the refrigerant is being expanded in the heat exchanger, the refrigerant may absorb heat from the indoor air, and the indoor space may be cooled. While the refrigerant is being compressed in the heat exchanger, the refrigerant may discharge heat to the indoor air, and the indoor space may be heated.

In order to control a target temperature, the processor 210 may change the target temperature value of the indoor unit 100a and indoor unit 100c and may adjust the motor rotational speed of the compressor to adjust the indoor temperature. For example, when a target temperature is set by a user of the processor 210, the processor 210 may adjust motor revolutions per minute (RPM) according to the target temperature. When the indoor temperature detected by the temperature sensors 110 is higher than a temperature set by the user, the processor 210 may perform a control operation to increase the compressor motor RPM, and when the indoor temperature detected by the temperature sensors 110 is lower than a temperature set by the user, the processor 210 may decrease the motor RPM or stop a compressor motor.

The processor 210 may control a wind door or a blade of the indoor unit 100a and indoor unit 100c to switch the indoor units 100a and 100c into a windless mode. The indoor unit 100a and indoor unit 100c may operate in the windless mode by discharging air while the wind door is closed. The processor 210 may generate a control signal to close the wind door and may output the control signal to the air conditioning module 212. The air conditioning module 212 may close the wind door in response to the control signal input from the processor 210 and may operate in the windless mode.

Also, the processor 210 may control a fan speed of the air conditioning module 212 in order to control the wind intensity. The processor 210 may generate a control signal to control the fan speed and may output the control signal to the air conditioning module 212. The air conditioning module 212 may control the fan speed in response to the control signal input from the processor 210. The air conditioning module 212 may blow air weakly as gentle wind, strongly as strong wind, or the like by controlling the fan speed.

According to an embodiment of the disclosure, while the air conditioning module 212 is performing the air conditioning operation, the processor 210 may calculate the corrected temperature detection value by applying the temperature correction parameter to the temperature detection value of the temperature sensor 110 in the abnormal state. While the air conditioning operation is being performed, the processor 210 may calculate, in real time, the corrected temperature detection value, by applying the temperature correction parameter to the temperature detection value of the temperature sensor 110 in the abnormal state generated in real time. The processor 210 may control the air conditioning operation by using the corrected temperature detection value.

The memory 214 may store various information, data, instructions, programs, etc. required for an operation of the air conditioner 100. The memory 214 may include at least one of volatile memory or non-volatile memory or a combination thereof. The memory 214 may include at least one type of storage medium from among a flash memory type, a hard disk type, a multimedia card micro type, a card-type memory (e.g., secure digital (SD) or extreme digital (XD) memory), random-access memory (RAM), static RAM (SRAM), read-only memory (ROM), electrically erasable programmable (ROM) (EEPROM), programmable ROM (PROM), magnetic memory, a magnetic disk, and an optical disk. Also, the memory 214 may correspond to a web storage or a cloud server performing a storage function on the Internet.

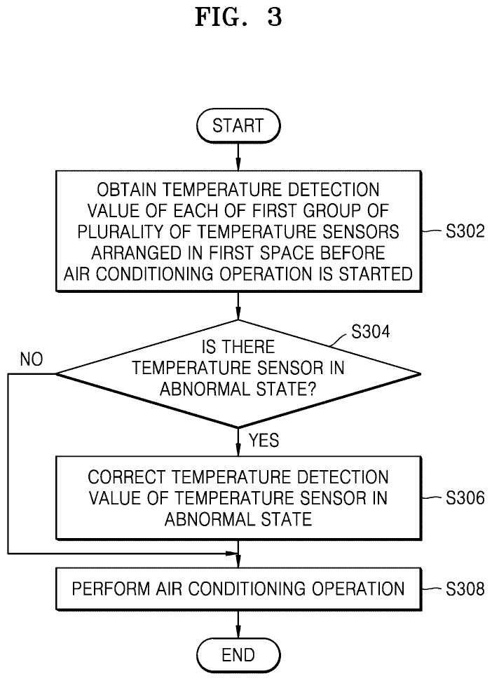

FIG. 3 is a flowchart of a controlling method for an air conditioner, according to an embodiment of the disclosure.

The controlling method for the air conditioner, according to an embodiment of the disclosure, may be performed by the air conditioner 100 of FIG. 1, according to an embodiment of the disclosure.

Referring to FIG. 3, an air conditioner 100 may obtain a temperature detection value of each of a first group of a plurality of temperature sensors 110 arranged in a first space 120a before an air conditioning operation is started, in operation S302. According to an embodiment of the disclosure, a time point before the air conditioning operation is started may denote a time point before a compressor operation is started. The air conditioner 100 may obtain the temperature detection value of each of the plurality of temperature sensors 110, with respect to other spaces in addition to the first space 120a. For example, the air conditioner 100 may obtain the temperature detection value of each of a second group of the plurality of temperature sensors 110 arranged in the second space 120b corresponding to the outdoor unit 100b before the air conditioning operation is started. Also, for example, the air conditioner 100 may obtain the temperature detection value of each of a third group of the plurality of temperature sensors 110 arranged in the third space 120c corresponding to the indoor unit 100c before the air conditioning operation is started.

Next, in operation S304, the air conditioner 100 may determine whether or not there is a temperature sensor 110 in an abnormal state, based on the temperature detection value of each of the temperature sensors 110. The air conditioner 100 may determine whether or not there is the temperature sensor 110 in the abnormal state by using the temperature detection value of each of the plurality of temperature sensors 110 of the same group. According to an embodiment of the disclosure, the air conditioner 100 may perform an operation of detecting the temperature sensor 110 in the abnormal state, when the plurality of temperature sensors 110 of the same group include three or more temperature sensors. When the plurality of temperature sensors 110 of the same group include two or less temperature sensors 110, the air conditioner 100 may not perform the operation of detecting the temperature sensor 110 in the abnormal state by using the temperature detection values. For example, the air conditioner 100 may detect the temperature sensor 110 in the abnormal state from among the first group of the temperature sensors 110 by using three or more temperature sensors 110 of the first group in the indoor unit 100a. Also, the air conditioner 100 may detect the temperature sensor 110 in the abnormal state from among the second group of the temperature sensors 110 by using the temperature detection value of each of three or more temperature sensors 110 of the second group. Also, the air conditioner 100 may detect the temperature sensor 110 in the abnormal state from among the third group of the temperature sensors 110 by using the temperature detection value of each of three or more temperature sensors 110 of the third group.

In operation S304, with respect to the temperature detection value of each of the plurality of temperature sensors 110 of the same group, the air conditioner 100 may determine whether or not the corresponding temperature sensor is in the abnormal state. For example, a process of detecting the temperature sensor 110 in the abnormal state is described, with respect to a case where the first group of the temperature sensors 110 include three temperature sensors 110, that is, a first temperature sensor 110a1, a second temperature sensor 110a2, and a third temperature sensor 110a3. The air conditioner 100 may compare a first temperature detection value of the first temperature sensor 110al of the first group with each of a second temperature detection value of the second temperature sensor 110a2 and a third temperature detection value of the third temperature sensor 110a3. The air conditioner 100 may determine whether or not the difference value between the first temperature detection value and the second temperature detection value exceeds a first reference value. Also, the air conditioner 100 may determine whether or not the difference value between the first temperature detection value and the third temperature detection value exceeds the first reference value. When the first temperature detection value is different from the second temperature detection value or the third temperature detection value by a value greater than the first reference value, the air conditioner 100 may determine whether or not the difference between the second temperature detection value and the third temperature detection value is less than a second reference value. When the first temperature detection value is different from the second temperature detection value or the third temperature detection value by the value greater than the first reference value, and the difference between the second temperature detection value and the third temperature detection value is less than the second reference value, the air conditioner 100 may determine that the first temperature sensor 110al is in an abnormal state.

The air conditioner 100 may determine whether or not each of the temperature sensors 110 in each group is in an abnormal state.

When there is the temperature sensor 110 in the abnormal state, the air conditioner 100 may correct the temperature detection value of the temperature sensor 110 in the abnormal state, in operation S306. The air conditioner 100 may correct the temperature detection value of the temperature sensor 110 in the abnormal state by using the temperature detection values of the other temperature sensors 110 of the same group in which the temperature sensor 110 in the abnormal state is included. For example, when the temperature sensor 110 in the abnormal state is the temperature sensor 110 of the first group, the air conditioner 100 may correct the temperature detection value of the temperature sensor 110 in the abnormal state by using the temperature detection values of the other temperature sensors 110 of the first group except for the temperature sensor 110 in the abnormal state. As described above, the air conditioner 100 may correct the temperature detection value of the temperature sensor 110 in the abnormal state by using the average value of the temperature detection values of the other temperature sensors 110 of the same group in which the temperature sensor 110 in the abnormal state is included.

The air conditioner 100 may calculate a temperature correction parameter for correcting the temperature detection value of the temperature sensor 110 in the abnormal state before the air conditioning operation is started. When the air conditioning operation is started subsequently, the air conditioner 100 may correct the temperature detection value of the temperature sensor 110 in the abnormal state, detected in real time, by using the temperature correction parameter calculated before the air conditioning operation.

When there are a plurality of temperature sensors 110 in the abnormal state, the air conditioner 100 may calculate the temperature correction parameter with respect to each of the plurality of temperature sensors 110 in the abnormal state. For example, when the temperature sensor 110 in the abnormal state is detected from among the temperature sensors 110 of the first group and the temperature sensor 110 in the abnormal state is detected from among the temperature sensors 110 of the second group, the temperature correction parameter may be calculated with respect to each of the temperature sensors 110 in the abnormal state. Also, the air conditioner 100 may correct the temperature detection value by using the temperature correction parameter calculated with respect to each of the temperature sensors 110 in the abnormal state.

Next, the air conditioner 100 may perform the air conditioning operation, in operation S308. The air conditioner 100 may perform the air conditioning operation by controlling the air conditioning module 212 according to a target temperature set by a user. The air conditioner 100 may start the compressor operation in operation S308. When the temperature sensor 110 in the abnormal state is not detected in operation S304, the air conditioner 100 may control the air conditioning operation by using the temperature detection value of each of the plurality of temperature sensors 110, without correcting the temperature detection value. When the temperature sensor 110 in the abnormal state is detected in operation S304, the air conditioner 100 may control the air conditioning operation by using the corrected temperature detection value of the temperature sensor 110 in the abnormal state and the temperature detection values of the temperature sensors 110 in a normal state.

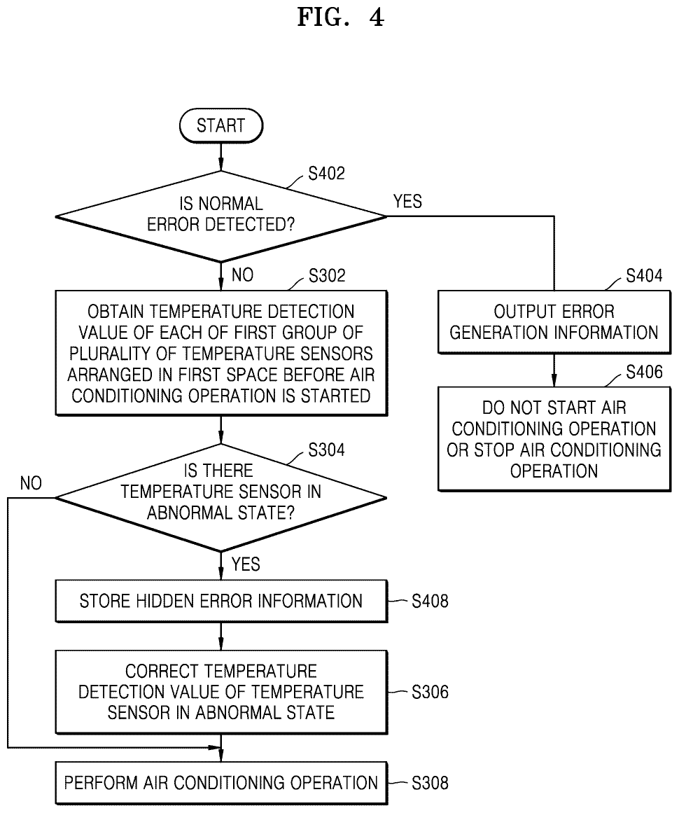

FIG. 4 is a flowchart of a controlling method for an air conditioner, according to an embodiment of the disclosure.

According to an embodiment of the disclosure, when the temperature detection value is not output from the temperature sensor 110, the air conditioner 100 may generate a normal error, and then, may stop the operation of the air conditioner 100. Also, when the normal error is not generated, the air conditioner 100 may perform an operation of detecting the temperature sensor 110 in the abnormal state.

Referring to FIG. 4, an air conditioner 100 may determine whether or not the normal error is detected, in operation S402. When power is turned on, the air conditioner 100 may perform operation S402. The normal error may be a case where the temperature detection value is not output from at least one of the plurality of temperature sensors 110. As an example of the case where the normal error is generated, there may be a case where a short circuit or an open circuit occurs in an internal circuit or a peripheral circuit of the temperature sensor 110. When a short circuit or an open circuit occurs in the internal circuit or the peripheral circuit of the temperature sensor 110, the temperature detection value may not be output or an invalid value may be output from the temperature sensor 110. Also, as an example of the case where the normal error is generated, there may be a case where a connector of the temperature sensor 110 is released. When the connector of the temperature sensor 110 is released, the temperature detection value may not be output from the temperature sensor 110. Even when the normal error is generated in only one of the plurality of temperature sensors 110, the air conditioner 100 may determine that the normal error is detected. Also, when the normal error is generated in any one separate device from among the indoor unit 100a, the indoor unit 100c, and the outdoor unit 100b, the air conditioner 100 may determine that the normal error is detected.

When the normal error is detected, the air conditioner 100 may output error generation information, in operation S404. According to an embodiment of the disclosure, the air conditioner 100 may output the error generation information through an output interface (not shown) of the air conditioner 100. For example, the air conditioner 100 may display an error generation message that an error is generated, through a display of the air conditioner 100, or may output the error generation message through a speaker as an audio signal. Also, according to an embodiment of the disclosure, the air conditioner 100 may output the error generation information to an external device. For example, the air conditioner 100 may output the error information to a server through a communication module, and the server may output the error generation information through a communication terminal, etc.

The air conditioner 100 may stop the air conditioning operation, in operation S406. When the air conditioner 100 has not yet started the air conditioning operation, the air conditioner 100 may not start the air conditioning operation.

When the normal error is not detected in operation S402, the air conditioner 100 may obtain, before the air conditioning operation, the temperature detection value of each of the plurality of temperature sensors 110 of the first group arranged in the first space, in operation S302. The air conditioner 100 may obtain the temperature detection value of each of the plurality of temperature sensors 110, with respect to other spaces in addition to the first space.

Next, in operation S304, the air conditioner 100 may determine whether or not there is the temperature sensor 110 in the abnormal state, based on the obtained temperature detection value of each of the temperature sensors 110. The air conditioner 100 may determine whether or not there is the temperature sensor 110 in the abnormal state by using the temperature detection value of each of the plurality of temperature sensors 110 of the same group. With respect to the temperature detection value of each of the plurality of temperature sensors 110 of the same group, the air conditioner 100 may determine whether or not the corresponding temperature sensor is in the abnormal state, in operation S304. The air conditioner 100 may determine whether or not each of the temperature sensors 110 in each group is in the abnormal state.

When the temperature sensor 110 in the abnormal state is detected in operation S304, the air conditioner 100 may store hidden error information, in operation S408. The air conditioner 100 may generate a hidden error when the temperature sensor 110 in the abnormal state is detected when the normal error is not generated. When the hidden error is generated, the air conditioner 100 may correct the temperature detection value of the temperature sensor 110 in the abnormal state and may perform the air conditioning operation by using the corrected temperature detection value. Thus, even when the hidden error is generated, the air conditioner 100 may not stop the air conditioning operation and may perform the air conditioning operation. When the hidden error is generated, the air conditioner 100 may store the hidden error information. The hidden error information may include at least one of identification information of the temperature sensor 110 in the abnormal state, a pattern of the temperature detection value, a temperature correction parameter, or a date and time when the hidden error is generated. By storing the hidden error information, the air conditioner 100 may allow a manager, a technician, etc. to subsequently refer to the hidden error information.

Also, the air conditioner 100 may correct the temperature detection value of the temperature sensor 110 in the abnormal state in operation S306. The air conditioner 100 may correct the temperature detection value of the temperature sensor 110 in the abnormal state by using the temperature detection values of the other temperature sensors 110 of the same group in which the temperature sensor 110 in the abnormal state is included. The air conditioner 100 may calculate the temperature correction parameter for correcting the temperature detection value of the temperature sensor 110 in the abnormal state, before the air conditioning operation is started.

Next, the air conditioner 100 may perform the air conditioning operation, in operation S308. The air conditioner 100 may perform the air conditioning operation by controlling the air conditioning module 212 according to a target temperature set by a user. The air conditioner 100 may start the compressor operation in operation S308. When the temperature sensor 110 in the abnormal state is not detected in operation S304, the air conditioner 100 may control the air conditioning operation by using the temperature detection value of each of the plurality of temperature sensors 110, without correcting the temperature detection value. When the temperature sensor 110 in the abnormal state is detected in operation S304, the air conditioner 100 may control the air conditioning operation by using the corrected temperature detection value of the temperature sensor 110 in the abnormal state and the temperature detection values of the temperature sensors 110 in the normal state.

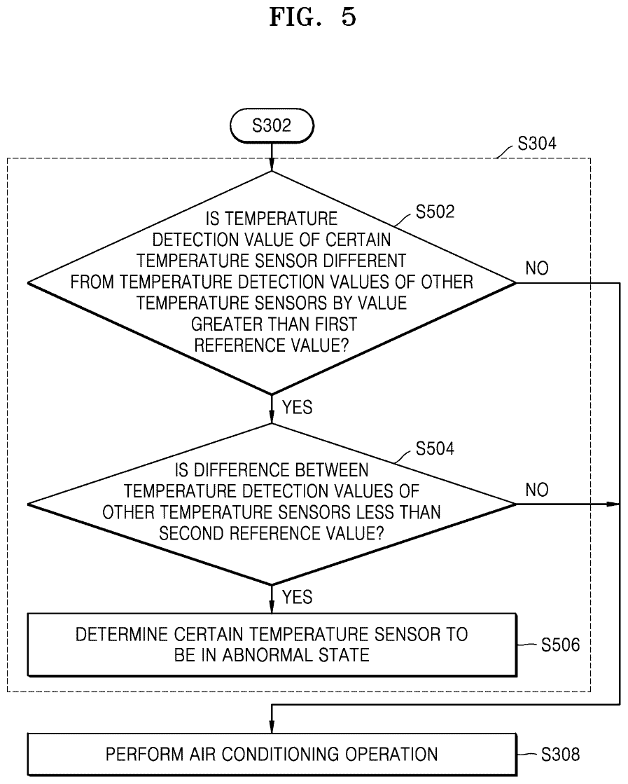

FIG. 5 is a diagram showing a process of determining whether or not there is a temperature sensor in an abnormal state, according to an embodiment of the disclosure.

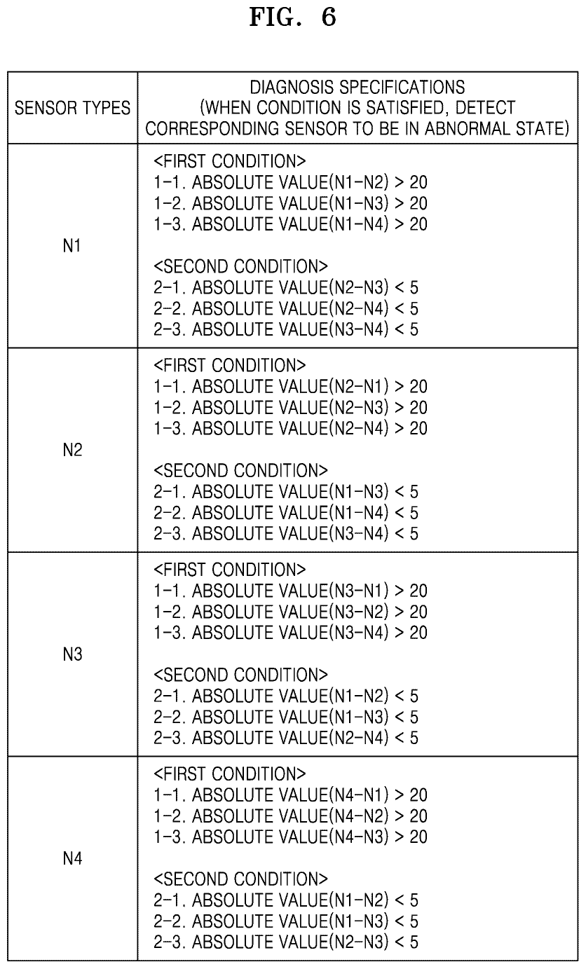

FIG. 6 is a diagram showing an example of a process of detecting a temperature sensor in an abnormal state, according to an embodiment of the disclosure.

Referring to FIGS. 5 and 6, the process of detecting a temperature sensor 110 in the abnormal state is described, according to an embodiment of the disclosure.

According to an embodiment of the disclosure, the air conditioner 100 may perform operation S304 with respect to each of the plurality of temperature sensors 110 included in the air conditioner 100. Operation S304 may include operations S502, S504, and S506. Referring to FIG. 6, when a first group includes a temperature sensor N1, a temperature sensor N2, a temperature sensor N3, and a temperature sensor N4, whether or not each of the temperature sensors N1 to N4 is in an abnormal state may be determined.

Referring to FIG. 5, in operation S502, an air conditioner 100 may determine whether or not a temperature detection value of a corresponding temperature sensor 110 is different from temperature detection values of the other temperature sensors 110 of the same group by a value greater than a first reference value. The determination of operation S502 may be performed based on a first condition of FIG. 6.

Referring to FIG. 6, in order to determine the first condition with respect to the temperature sensor N1, an air conditioner 100 may determine whether or not the absolute value of the difference between the temperature detection value of the temperature sensor N1 and the temperature detection value of the temperature sensor N2 exceeds a first reference value (condition 1-1). Also, in order to determine the first condition, the air conditioner 100 may determine whether or not the absolute value of the difference between the temperature detection value of the temperature sensor N1 and the temperature detection value of the temperature sensor N3 exceeds the first reference value (condition 1-2). Also, in order to determine the first condition, the air conditioner 100 may determine whether or not the absolute value of the difference between the temperature detection value of the temperature sensor N1 and the temperature detection value of the temperature sensor N4 exceeds the first reference value (condition 1-3). Here, the first reference value may be set 20, for example. Also, the air conditioner 100 may determine the first condition with respect to each of the temperature sensors N2, N3, and N4 similarly as the temperature sensor N1.

The first condition may relate to determining whether or not the temperature detection value of the corresponding temperature sensor 110 is different from the temperature detection values of the other temperature sensors 110 of the same group. Before an air conditioning operation is started, the temperature detection values of the temperature sensors 110 of the same group in the same space may be detected to be similar to one another in a normal state. When a temperature detection value of a temperature sensor 110 is different from temperature detection values of the other temperature sensors 110 by a value exceeding the first reference value, the corresponding temperature sensor 110 may be likely to be in an abnormal state. As described above, the first condition may relate to detecting the case where the temperature detection value of the temperature sensor 110 is different from the temperature detection values of the other temperature sensors 110 of the same group.

When the corresponding temperature sensor 110 satisfies at least one of the plurality of first conditions (condition 1-1, condition 1-2, and condition 1-3) in operation S502, the air conditioner 100 may determine that the temperature detection value of the corresponding temperature sensor 110 is different from the temperature detection values of the other temperature sensors 110 of the same group by a value exceeding the first reference value. That is, when the corresponding temperature sensor 110 satisfies at least one of the plurality of first conditions (condition 1-1, condition 1-2, and condition 1-3), the air conditioner 100 may determine that the first condition is satisfied.

When the temperature detection value of the corresponding temperature sensor 110 is not different from the temperature detection values of the other temperature sensors 110 of the same group by the value exceeding the first reference value in operation S502, the air conditioner 100 may not determine that the corresponding temperature sensor 110 is in the abnormal state. When the temperature sensor 110 in the abnormal state is not detected in operation S502, the air conditioner 100 may perform the air conditioning operation by using the temperature detection values of the temperature sensors 110, in operation S308.

When the corresponding temperature sensor 110 satisfies at least one of condition 1-1, condition 1-2, or condition 1-3 of the first condition, the air conditioner 100 may determine whether or not the differences among the temperature detection values of the other temperature sensors 110 are less than a second reference value, in operation S504. The determination of operation S504 may be performed based on a second condition of FIG. 6.

Referring to FIG. 6, in order to determine the second condition with respect to temperature sensor N1, an air conditioner 100 may determine whether or not the absolute value of the difference between the temperature detection value of the temperature sensor N2 and the temperature detection value of the temperature sensor N3 is less than the second reference value (condition 2-1). Also, with respect to the temperature sensor N1, the air conditioner 100 may determine whether or not the absolute value of the difference between the temperature detection value of the temperature sensor N2 and the temperature detection value of the temperature sensor N4 is less than the second reference value (condition 2-2). Also, with respect to the temperature sensor N1, the air conditioner 100 may determine whether or not the absolute value of the difference between the temperature detection value of the temperature sensor N3 and the temperature detection value of the temperature sensor N4 is less than the second reference value (condition 2-3). Here, the second reference value may be set as 5, for example. When all of the plurality of second conditions (condition 2-1, condition 2-2, and condition 2-3) are satisfied, the air conditioner 100 may determine that the second condition is satisfied. The air conditioner 100 may determine the second condition with respect to each of the temperature sensors N2, N3, and N4 similarly as the temperature sensor N1.

When, with respect to the first condition, it is determined that the temperature detection value of the temperature sensor 110 is different from the temperature detection values of the other temperature sensors of the same group, the corresponding temperature sensor 110 may be in the abnormal state or the other temperature sensors 110 of the same group having the different temperature detection values may be in the abnormal state. The second condition may relate to determining whether the corresponding temperature sensor 110 is in the abnormal state and the other temperature sensors 110 of the same group are in a normal state. When the other temperature sensors 110 of the same group are in the abnormal state, the second condition may not be satisfied.

Referring to FIG. 5 again, when it is determined that the differences among the temperature detection values of the other temperature sensors 110 are less than the second reference value in operation S504, the air conditioner 100 may determine the corresponding temperature sensor 110 to be in the abnormal state, in operation S506. As described above, the air conditioner 100 may correct the temperature detection value of the temperature sensor 110 in the abnormal state and may perform the air conditioning operation by using the corrected temperature detection value.

When the differences among the temperature detection values of the other temperature sensors 110 of the same group exceed the second reference value in operation S504, the air conditioner 100 may not determine that the corresponding temperature sensor 110 is in the abnormal state. When any one the second conditions is not satisfied, the air conditioner 100 may not determine that the corresponding temperature sensor 110 is in the abnormal state.

The air conditioner 100 may determine whether or not the second condition is satisfied with respect to each of the plurality of temperature sensors 110 in operation S504. When there is the temperature sensor 110 satisfying the first condition, the air conditioner 100 may detect the temperature sensors 110 satisfying the second condition to identify the temperature sensor 110 in the abnormal state.

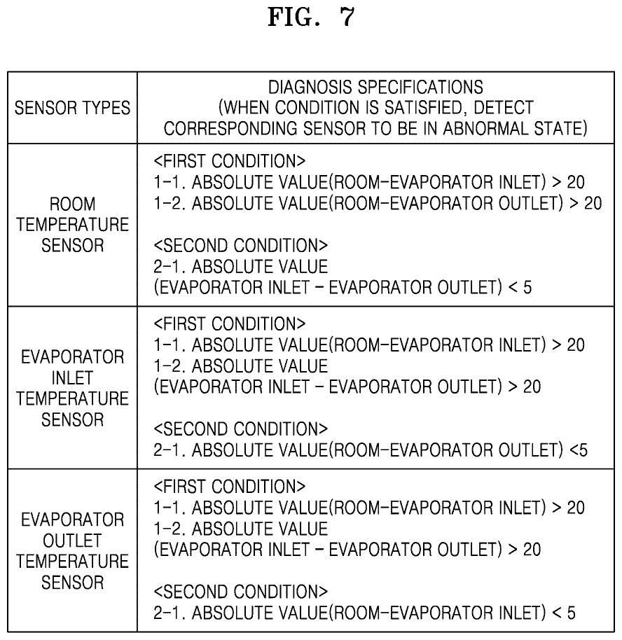

FIG. 7 is a diagram showing a process of determining an abnormal state of a temperature sensor of an indoor unit, according to an embodiment of the disclosure.

Referring to FIG. 7, a case where indoor unit 100a or indoor unit 100c includes three temperature sensors 110 is described as an example. A first group of the three temperature sensors 110 included in the indoor unit 100a or the indoor unit 100c may include a room temperature sensor, an evaporator inlet temperature sensor, and an evaporator outlet temperature sensor.

The air conditioner 100 may first determine the first condition with respect to the room temperature sensor. The air conditioner 100 may determine whether the absolute value of the difference between a temperature detection value of the room temperature sensor and a temperature detection value of the evaporator inlet temperature sensor exceeds the first reference value (for example, 20) (condition 1-1). Also, the air conditioner 100 may determine whether the absolute value of the difference between the temperature detection value of the room temperature sensor and a temperature detection value of the evaporator outlet temperature sensor exceeds the first reference value (for example, 20) (condition 1-2). When the temperature detection value of the room temperature sensor does not satisfy the first condition, the air conditioner 100 may not determine that the room temperature sensor is in the abnormal state. When the temperature detection value of the room temperature sensor does not satisfy the first condition, the air conditioner 100 may not determine the second condition. When the temperature detection value of the room temperature sensor satisfies at least one of condition 1-1 or condition 1-2, the air conditioner 100 may determine whether or not the second condition is satisfied. The air conditioner 100 may determine whether the absolute value of the difference between the temperature detection value of the evaporator inlet temperature sensor and the temperature detection value of the evaporator outlet temperature sensor is less than the second reference value (for example, 5). When the second condition is satisfied, the air conditioner 100 may determine that the room temperature sensor is in the abnormal state.

Also, with respect to the evaporator inlet temperature sensor, the air conditioner 100 may first determine the first condition. The air conditioner 100 may determine whether the absolute value of the difference between the temperature detection value of the evaporator inlet temperature sensor and the temperature detection value of the room temperature sensor exceeds the first reference value (for example, 20) (condition 1-1). Also, the air conditioner 100 may determine whether the absolute value of the difference between the temperature detection value of the evaporator inlet temperature sensor and the temperature detection value of the evaporator outlet temperature sensor exceeds the first reference value (for example, 20) (condition 1-2). When the temperature detection value of the evaporator inlet temperature sensor does not satisfy the first condition, the air conditioner 100 may not determine that the evaporator inlet temperature sensor is in the abnormal state. When the temperature detection value of the evaporator inlet temperature sensor does not satisfy the first condition, the air conditioner 100 may not determine the second condition. When the temperature detection value of the evaporator inlet temperature sensor satisfies at least one of condition 1-1 or condition 1-2, the air conditioner 100 may determine whether or not the second condition is satisfied. The air conditioner 100 may determine whether the absolute value of the difference between the temperature detection value of the room temperature sensor and the temperature detection value of the evaporator outlet temperature sensor is less than the second reference value (for example, 5). When the second condition is satisfied, the air conditioner 100 may determine that the evaporator inlet temperature sensor is in the abnormal state.

Also, with respect to the evaporator outlet temperature sensor, the air conditioner 100 may first determine the first condition. The air conditioner 100 may determine whether or not the absolute value of the difference between the temperature detection value of the evaporator outlet temperature sensor and the temperature detection value of the room temperature sensor exceeds the first reference value (for example, 20) (condition 1-1). Also, the air conditioner 100 may determine whether or not the absolute value of the difference between the temperature detection value of the evaporator outlet temperature sensor and the temperature detection value of the evaporator inlet temperature sensor exceeds the first reference value (for example, 20) (condition 1-2). When the temperature detection value of the evaporator outlet temperature sensor does not satisfy the first condition, the air conditioner 100 may not determine that the evaporator outlet temperature sensor is in the abnormal state. When the temperature detection value of the evaporator outlet temperature sensor does not satisfy the first condition, the air conditioner 100 may not determine the second condition. When the temperature detection value of the evaporator outlet temperature sensor satisfies at least one of condition 1-1 or condition 1-2, the air conditioner 100 may determine whether or not the second condition is satisfied. The air conditioner 100 may determine whether the absolute value of the difference between the temperature detection value of the room temperature sensor and the temperature detection value of the evaporator inlet temperature sensor is less than the second reference value (for example, 5). When the second condition is satisfied, the air conditioner 100 may determine that the evaporator outlet temperature sensor is in the abnormal state.

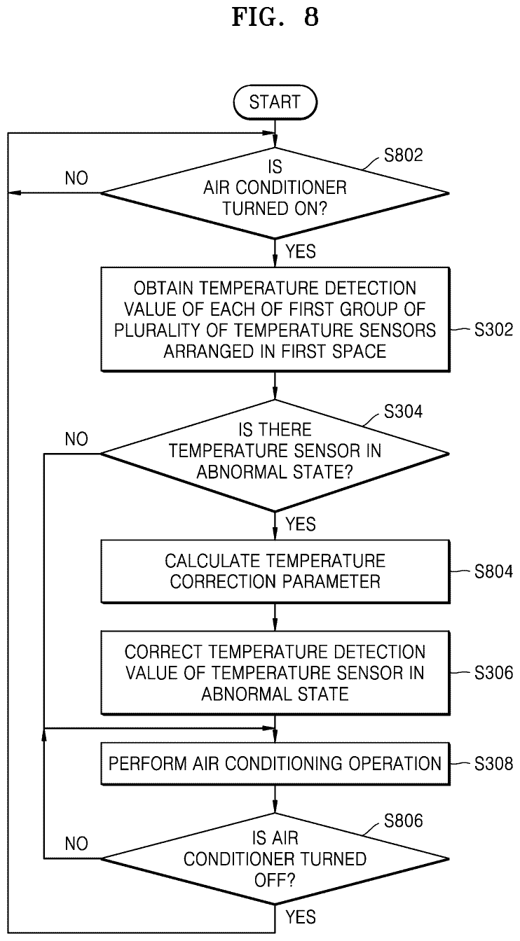

FIG. 8 is a flowchart of a controlling method for an air conditioner, according to an embodiment of the disclosure.

According to an embodiment of the disclosure, whenever power is turned on, the air conditioner 100 may determine whether or not there is the temperature sensor 110 in the abnormal state and may calculate the temperature correction parameter of the temperature sensor 110 in the abnormal state.

Referring to FIG. 8, when an air conditioner 100 is turned on, in operation S802, the air conditioner 100 may obtain the temperature detection value of each of a plurality of temperature sensors 110 of the first group arranged in the first space, in operation S302. When the air conditioner 100 is turned on, the air conditioner 100 may obtain the temperature detection value of each of the temperature sensors 110 in operation S302 before starting the air conditioning operation.

Next, the air conditioner 100 may determine whether or not there is the temperature sensor 110 in the abnormal state in operation S304.

When it is not determined that there is the temperature sensor 110 in the abnormal state, the air conditioner 100 may perform the air conditioning operation, in operation S308. When it is not determined that there is the temperature sensor 110 in the abnormal state, the air conditioner 100 may start the compressor operation.

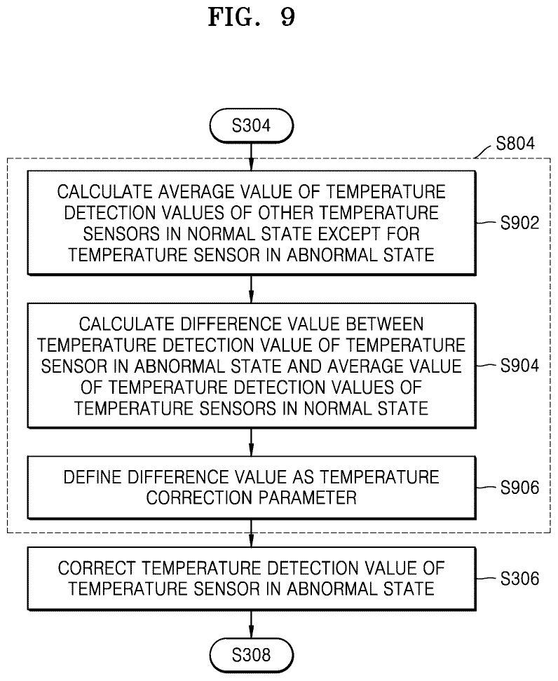

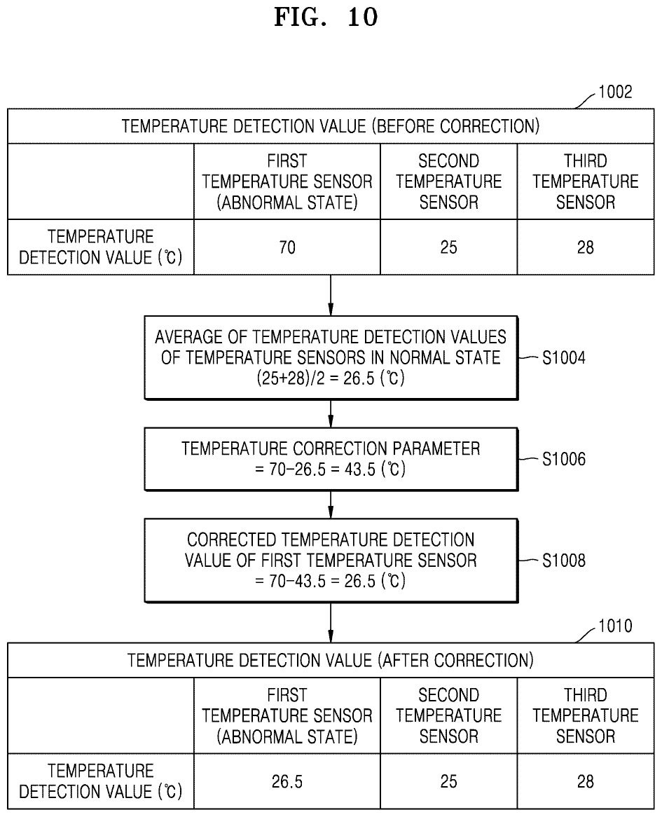

When it is determined that there is the temperature sensor 110 in the abnormal state, the air conditioner 100 may calculate the temperature correction parameter of the temperature sensor 110 in the abnormal state, in operation S804. The air conditioner 100 may calculate the temperature correction parameter by using the temperature detection values of the other temperature sensors 110 of the same group except for the temperature sensor 110 in the abnormal state. The process of calculating the temperature correction parameter is described below with reference to FIGS. 9 and 10. The air conditioner 100 may calculate the temperature correction parameter whenever the air conditioner 100 is turned on.

Next, the air conditioner 100 may correct the temperature detection value of the temperature sensor 110 in the abnormal state by using the temperature correction parameter, in operation S306.

Next, the air conditioner 100 may perform the air conditioning operation, in operation S308. The air conditioner 100 may perform the air conditioning operation by using the corrected temperature detection value of the temperature sensor 110 in the abnormal state and the temperature detection values of the temperature sensors 110 in a normal state. The air conditioner 100 may start the compressor operation, in operation S308.

Next, when it is determined that the air conditioner 100 is turned off, in operation S806, the air conditioner 100 may end the air conditioning operation of the air conditioner 100 until the air conditioner 100 is turned on again. When the air conditioner 100 is turned on again subsequently, the air conditioner 100 may repeat operations S302, S304, S804, S306, and S308.

According to an embodiment of the disclosure, when the air conditioner 100 is turned on, the air conditioner 100 may perform the operation of detecting the temperature sensor 110 in the abnormal state by using the temperature detection value of each of the plurality of temperature sensors 110 of the first group, when a reference time period or longer passes from a last time point at which the air conditioner 100 is turned off. When an enough time period does not pass from the last time point at which the air conditioner 100 is turned off, the temperature detection values of the temperature sensors 110 of the same group of the air conditioner 100 may not be uniform in a natural state before the air conditioning operation and may be different from each other due to effects of a previous air conditioning operation. In this case, the air conditioner 100 may wrongly detect the abnormal state of the temperature sensor 110. According to an embodiment of the disclosure, by performing the operation of detecting the temperature sensor 110 in the abnormal state only after the reference time period or longer passes from the last time point at which the air conditioner 100 is turned off, it may be prevented to wrongly detect the temperature sensor 110 in the abnormal state.

FIG. 9 is a flowchart of a process of calculating a temperature correction parameter and correcting a temperature detection value, according to an embodiment of the disclosure.

FIG. 10 is a diagram showing an example of a process of calculating a temperature correction parameter and correcting a temperature detection value, according to an embodiment of the disclosure.

Referring to FIGS. 9 and 10, the process of calculating the temperature correction parameter and correcting the temperature detection value will be described, according to an embodiment of the disclosure.

According to an embodiment of the disclosure, an air conditioner 100 may correct the temperature detection value of a temperature sensor 110 in the abnormal state, by using the temperature detection values of the temperature sensors 110 of the same group, the temperature sensors 110 being in the normal state.

Referring to FIG. 9, an air conditioner 100 may calculate the average value of the temperature detection values of other temperature sensors 110 of the same group except for the temperature sensor in the abnormal state, in operation S902. When the temperature sensor 110 in the abnormal state is the temperature sensor 110 of a first group, the air conditioner 100 may calculate the average value of the temperature detection values of the other temperature sensors 110 of the first group except for the temperature sensor 110 in the abnormal state.

Operation S902 is described with reference to FIG. 10. In the example of FIG. 10, the first group of the temperature sensors 110 may include a first temperature sensor, a second temperature sensor, and a third temperature sensor. The first temperature sensor may correspond to the temperature sensor 110 in the abnormal state. Referring to FIG. 10, as shown in table 1002, the air conditioner 100 may obtain a temperature detection value of each of the first temperature sensor, the second temperature sensor, and the third temperature sensor.

In operation S1004, the air conditioner 100 may calculate the average of the temperature detection values of the second temperature sensor and the third temperature sensor that are in the normal state. For example, when the temperature detection value of the second temperature sensor is 25° C. and the temperature detection value of the third temperature sensor is 28° C., the average of the temperature detection values of the second temperature sensor and the third temperature sensor that are in the normal state may be 26.5° C.

Referring to FIG. 9, in operation S904, an air conditioner 100 may calculate the difference value between the temperature detection value of the temperature sensor 110 in the abnormal state and the average value of the temperature detection values of the temperature sensors in the normal state. The air conditioner 100 may define the difference value calculated above in operation S904 as the temperature correction parameter, in operation S906.

Referring to FIG. 10, in operation S1006, an air conditioner 100 may calculate the difference value between the temperature detection value of 70° C. of the first temperature sensor in the abnormal state and the average value of 26.5° C. of the temperature detection values of the second and third temperature sensors in the normal state. The air conditioner 100 may define the difference value of 43.5° C. as the temperature correction parameter.

Referring to FIG. 9, an air conditioner 100 may correct the temperature detection value of the temperature sensor 110 in the abnormal state by using the temperature correction parameter in operation S306. The operation of correcting the temperature detection value of the temperature sensor in the abnormal state may be repeatedly performed on the temperature detection value of the temperature sensor 110 in the abnormal state while the air conditioning operation is being performed.

Referring to FIG. 10, an air conditioner 100 may correct the temperature detection value of the first temperature sensor by using the temperature correction parameter, in operation S1008. The air conditioner 100 may define 26.5° C., which is obtained by subtracting the temperature correction parameter from the temperature detection value of the first temperature sensor, as the corrected temperature detection value. As shown in table 1010, the air conditioner 100 may obtain the corrected temperature detection value obtained by correcting the temperature detection value of the first temperature sensor in the abnormal state. The air conditioner 100 may perform the air conditioning operation by using the corrected temperature detection value as shown in the table 1010.

The air conditioner 100 may periodically or continually calculate the temperature detection value while performing the air conditioning operation. The air conditioner 100 may apply the temperature correction parameter calculated before the air conditioning operation to the temperature detection value of the temperature sensor 110 in the abnormal state periodically or continually calculated, to obtain the corrected temperature detection value.

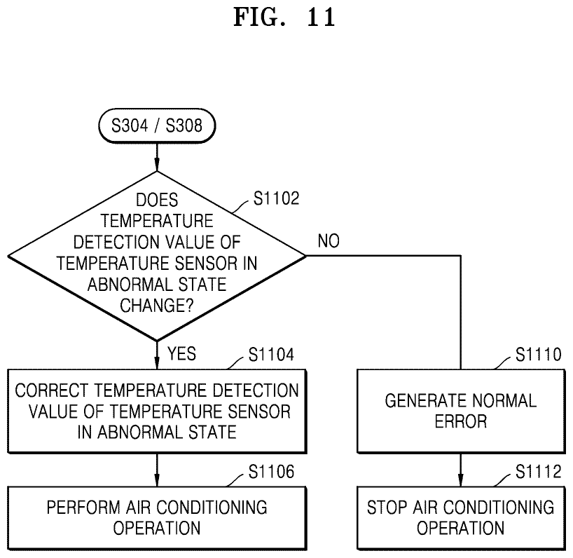

FIG. 11 is a diagram showing a process of generating an error, when a temperature sensor in an abnormal state is detected, according to an embodiment of the disclosure.

According to an embodiment of the disclosure, when the air conditioner 100 detects the temperature sensor 110 in the abnormal state, the air conditioner 100 may generate a normal error by referring to a temperature change pattern of the temperature sensor 110 in the abnormal state. When it is impossible to detect a temperature change because the temperature detection value of the temperature sensor 110 in the abnormal state reaches a threshold value, the air conditioner 100 may generate the normal error.

Referring to FIG. 11, an air conditioner 100 may determine whether or not a change in the temperature detection value of the temperature sensor 110 in the abnormal state is detected, in operation S1102. The air conditioner 100 may determine whether or not the temperature detection value of the temperature sensor 110 in the abnormal state changes by a third reference value or greater. For example, when the third reference value is 1° C. and the temperature detection value of the temperature sensor 110 in the abnormal state increases or decreases by 1° C. or greater, the air conditioner 100 may determine that the change in the temperature detection value of the temperature sensor 110 in the abnormal state is detected. When the temperature detection value of the temperature sensor 110 in the abnormal state does not increase or decrease by 1° C. or greater, the air conditioner 100 may not determine that the change in the temperature detection value of the air temperature sensor 110 in the abnormal state is detected.

According to an embodiment of the disclosure, the air conditioner 100 may determine, in operation S1102, whether or not the temperature detection value of the temperature sensor 110 in the abnormal state changes after the air conditioning operation is started. The temperature detection value of the temperature sensor 110 of the air conditioner 100 seldom changes before the air conditioning operation is started. Thus, the air conditioner 100 may determine whether or not the temperature detection value of the temperature sensor 110 in the abnormal state changes, after the air conditioning operation is started.

Also, according to an embodiment of the disclosure, the air conditioner 100 may determine, after the air conditioning operation is started, whether or not the temperature detection value of the temperature sensor 110 in the abnormal state changes by the third reference value or greater during a reference time period. For example, the reference time period may be set as one minute. When the temperature detection value of the temperature sensor 110 in the abnormal state does not change by the third reference value or greater during one minute, the air conditioner 100 may not determine that the change in the temperature detection value of the air temperature sensor 110 is detected.

Also, according to an embodiment of the disclosure, after the air conditioner 100 corrects the temperature detection value of the temperature sensor 110 in the abnormal state by using the temperature correction parameter, the air conditioner 100 may determine whether the corrected temperature detection value changes by the third reference value or greater, in operation S1102. When the corrected temperature detection value of the temperature sensor 110 in the abnormal state does not change by the third reference value or greater, the air conditioner 100 may not determine that the temperature detection value of the air temperature sensor 110 in the abnormal state changes.

When the temperature detection value of the temperature sensor 110 in the abnormal state does not change, the air conditioner 100 may generate the normal error, in operation S1110. When the temperature detection value of the temperature sensor 110 in the abnormal state is saturated as the maximum value or the minimum value of the output range of the temperature sensor 110, the temperature detection value may not change. In this case, even when the temperature detection value of the temperature sensor 110 in the abnormal state is corrected, the corrected temperature detection value may not reflect the actual temperature and may not be valid. In this case, the air conditioner 100 may operate by using the invalid temperature detection value, and thus, may have degraded air conditioning function. According to an embodiment of the disclosure, the inappropriate air conditioning operation may be prevented by generating the normal error when the temperature detection value of the temperature sensor 110 in the abnormal state does not change even when the air conditioning operation is started after generating the hidden error by detecting the temperature sensor 110 in the abnormal state.

When the normal error is generated in operation S1110, the air conditioner 100 may stop the air conditioning operation, in operation S1112. The air conditioner 100 may output a message that the normal error is generated in operation S1110 and may stop the air conditioning operation of the air conditioner 100.

When it is determined that the temperature detection value of the temperature sensor 110 in the abnormal state changes, in operation S1102, the air conditioner 100 may correct the temperature detection value of the temperature sensor 110 in the abnormal state, in operation S1104. The air conditioner 100 may perform the air conditioning operation by using the corrected temperature detection value, in operation S1106. The air conditioner 100 may perform the air conditioning operation when the hidden error is generated.

According to an embodiment of the disclosure, in operation S1102, the air conditioner 100 may determine whether or not the temperature detection value changes, by using the corrected temperature detection value of the temperature sensor 110 in the abnormal state. In this case, operation S1104 may be omitted, and operation S1106 may be performed.

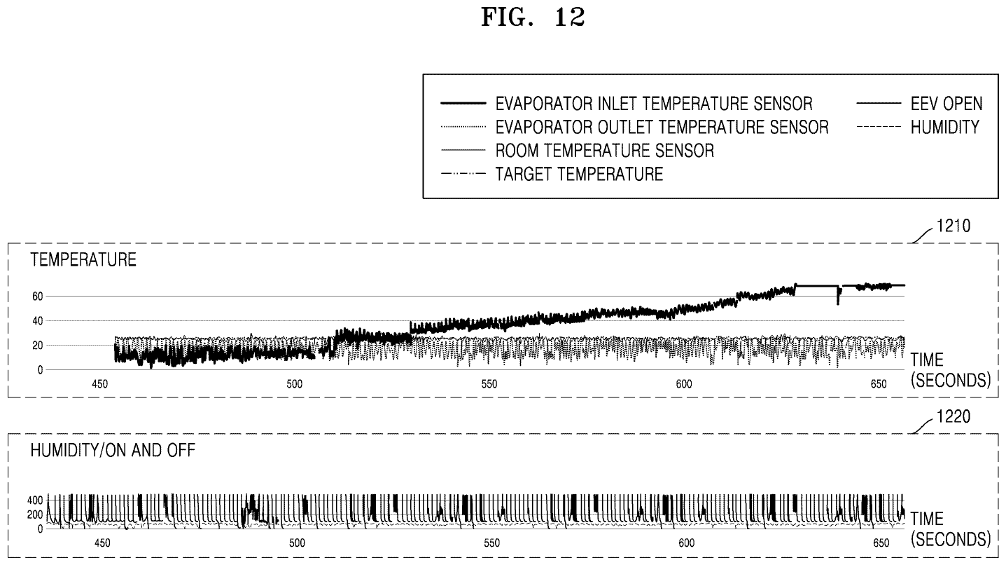

FIG. 12 is a diagram showing a temperature change of a temperature sensor in an abnormal state, according to an embodiment of the disclosure.

Referring to FIG. 12, graph 1210 shows a chronological temperature change of the first group of the temperature sensors 110 arranged in the indoor unit 100a and indoor unit 100c. The first group of the temperature sensors 110 may include an evaporator inlet temperature sensor, an evaporator outlet temperature sensor, and a room temperature sensor. In the graph 1210, a temperature detection value of the evaporator inlet temperature sensor, a temperature detection value of the evaporator outlet temperature sensor, and a temperature detection value of the room temperature sensor are illustrated. The evaporator inlet temperature sensor is detected to be in an abnormal state.

For example, the temperature sensor 110 in the abnormal state may be saturated as the maximum value of the temperature sensor 110. In the example illustrated in the graph 1210, the temperature detection value of the evaporator inlet temperature sensor reaches and maintains at 70° C., which is the maximum detection value of the temperature sensor 110. In this case, a change of the temperature detection value is not detected during a reference time period in the temperature detection value of the evaporator inlet temperature sensor. When the temperature detection value of the evaporator inlet temperature sensor is detected to be higher than a normal temperature as described above, an electric expansion valve (EEV) of the air conditioner 100 may become excessively closed. Also, the air conditioner 100 may enter into a freeze control under a high frequency condition.

Graph 1220 shows a humidity detection value and an EEV on and off pattern of the air conditioner 100, when the temperature detection value is obtained as shown in the graph 1210. As described above, when the temperature detection value of the evaporator inlet temperature sensor is measured to be higher than the normal temperature, the on and off pattern in which the EEV is excessively closed may be observed in the graph 1220.

According to an embodiment of the disclosure, as shown in the example of FIG. 12, when the temperature detection value of the temperature sensor 110 in the abnormal state is saturated as the maximum value or the minimum value, and thus, the change of the temperature detection value is not detected, a normal error may be generated to stop the air conditioning operation.

When the temperature detection value of the temperature sensor 110 in the abnormal state of the air conditioner 100 is saturated as the maximum value or the minimum value, various types of defects may be detected. For example, the temperature sensor 110 may have the temperature detection range of about −50° C. to about 70° C. In this case, the temperature detection value of the temperature sensor 110 in the abnormal state may be saturated as −50° C. and may not change or may be saturated as 70° C. and may not change.

When the room temperature sensor shows a temperature detection value higher than a normal temperature, a high frequency may be observed in the EEV on and off pattern. Also, because the current indoor temperature value which is output by the air conditioner 100 does not drop, a user may recognize that the air conditioner 100 is broken down. When the room temperature sensor shows a temperature detection value lower than a normal temperature (for example, detected as a low temperature of 18° C. or less), the heat exchanger and the compressor may not operate. In this case, because the air conditioning operation is not performed, the user may recognize that the air conditioner 100 is broken down.

When the evaporator inlet temperature sensor shows a temperature detection value higher than a normal temperature, the EEV may be excessively closed, and a freeze control may be entered into under a high frequency condition. When the evaporator inlet temperature sensor shows a temperature detection value lower than a normal temperature, the EEV may be excessively opened, and when the temperature is wrongly detected as a below-zero temperature, a freeze control may be entered into.

When the evaporator outlet temperature sensor shows a temperature detection value higher than a normal temperature, the EEV may be excessively opened. When the evaporator outlet temperature sensor shows a temperature detection value lower than a normal temperature, the EEV may be excessively closed, and a freeze control may be entered into under a high frequency condition.

According to an embodiment of the disclosure, when the temperature detection value of the temperature sensor 110 in the abnormal state is saturated and does not change, the normal error may be generated and the air conditioning operation may be stopped, as described above, and thus, the air conditioner 100 may be prevented from performing an inappropriate air conditioning operation.

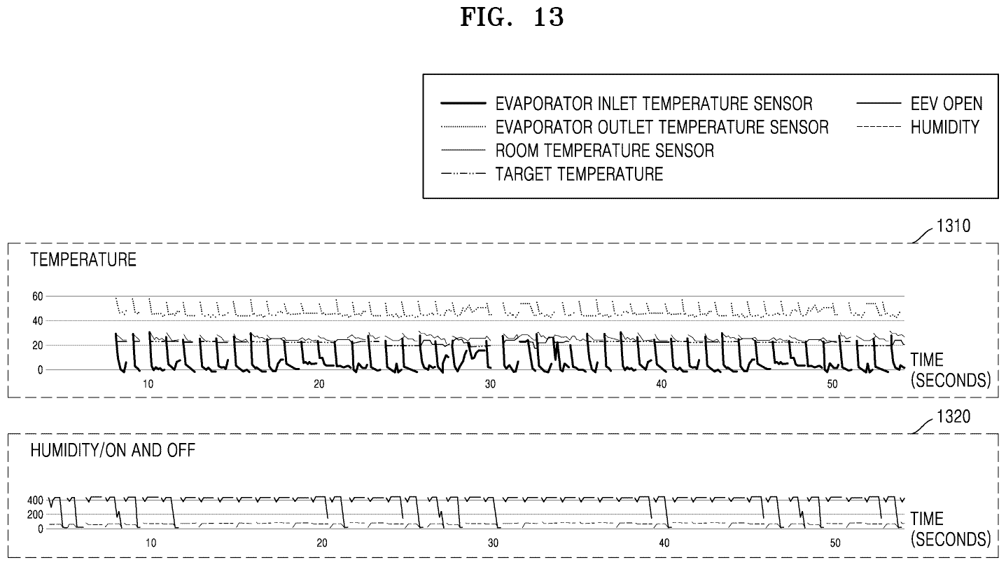

FIG. 13 is a diagram showing a temperature change of a temperature sensor in an abnormal state, according to an embodiment of the disclosure.

Referring to FIG. 13, graph 1310 shows a chronological temperature change of the first group of the temperature sensors 110 arranged in the indoor unit 100a and indoor unit 100c. The first group of the temperature sensors 110 may include an evaporator inlet temperature sensor, an evaporator outlet temperature sensor, and a room temperature sensor. In the graph 1310, a temperature detection value of the evaporator inlet temperature sensor, a temperature detection value of the evaporator outlet temperature sensor, and a temperature detection value of the room temperature sensor are illustrated. The evaporator inlet temperature sensor is detected to be in an abnormal state.

In the example illustrated in the graph 1310, the temperature detection value of the evaporator inlet temperature sensor may be higher than a normal temperature which would have been detected in the normal state, by an error temperature. As described above, when the temperature detection value of the evaporator inlet temperature sensor is detected to be higher than the normal temperature, the EEV may be excessively opened, and thus, the temperature of the discharged air may be increased. For example, as shown in graph 1320, the EEV may be excessively opened. Also, when the temperature detection value of the evaporator inlet temperature sensor is detected to be higher than the normal temperature, a liquid back phenomenon, in which a liquid refrigerant remains in a compressor suction gas, may occur.

However, the temperature detection value of the evaporator inlet temperature sensor shows a changing value according to time in the graph 1310. In this case, the temperature detection value of the evaporator inlet temperature sensor may be corrected to be similar as the normal temperature, by using the temperature correction parameter described above. According to an embodiment of the disclosure, as shown in the example of the graph 1310, when the temperature detection value of the temperature sensor 110 in the abnormal state changes, the air conditioner 100 may generate or maintain the hidden error and the air conditioning operation may be performed by correcting the temperature detection value.

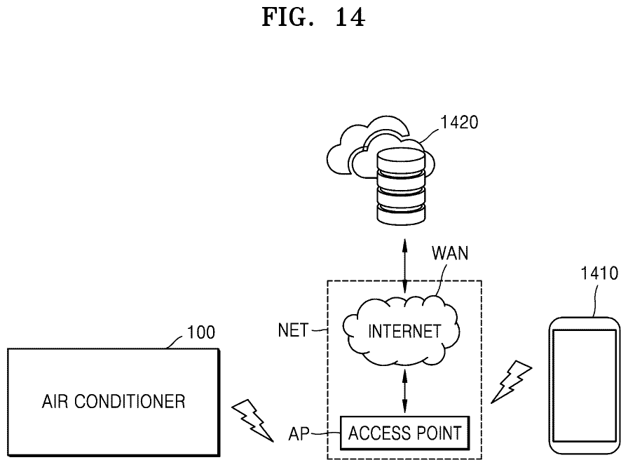

FIG. 14 is a diagram showing an air conditioner, an external device, and a server, according to an embodiment of the disclosure.

Referring to FIG. 14, according to an embodiment of the disclosure, an air conditioner 100 may communicate with an external device 1410 and a server 1420 through a communication module (not shown). The air conditioner 100 may be connected to other home appliances, the external device 1410, or the server 1420 through a network NET.

The server 1420 may manage user account information and information with respect to the air conditioner 100 linked to a user account. For example, a user may generate the user account by accessing the server 1420 through the external device 1410. The user account may be identified by an identifier and a password set by the user. The server 1420 may register the air conditioner 100 to the user account according to a predetermined procedure. For example, the server 1420 may register the air conditioner 100 by linking identification information (for example, a serial number or a media access control (MAC) address) of the air conditioner 100 to the user account.

The external device 1410 may include a communication module configured to communicate with the air conditioner 100 and the server 1420, a user interface configured to receive a user input or output information to the user, at least one processor configured to control an operation of the external device 1410, and at least one memory storing a program to control the operation of the external device 1410.

The external device 1410 may be handheld by the user or may be arranged in a user's house, office, or the like. The external device 1410 may include, for example, a personal computer, a terminal, a portable telephone, a smartphone, a handheld device, a wearable device, etc., but is not limited thereto.

The memory of the external device 1410 may store a program (for example, an application) to control the air conditioner 100. The external device 1410 may be sold with or without an application to control the air conditioner 100 being installed. When the external device 1410 is sold without the application to control the air conditioner 100 being installed, the user may download the application from an external server providing the application and install the application in the external device 1410.

The user may control the air conditioner 100 by using the application installed in the external device 1410. For example, when the user executes the application installed in the external device 1410, the identification information of the air conditioner 100 linked to the external device 1410 via the same user account may be displayed on an execution window of the application. The user may perform an intended controlling operation on the air conditioner 100 through the application execution window. When the user inputs a control command with respect to the air conditioner 100 through the application execution window, the external device 1410 may directly transmit the control command to the air conditioner 100 through a short-range wireless network or may transmit the control command to the air conditioner 100 through the server 1420.

The application of the external device 1410 may receive various user inputs to control the air conditioner 100. The application may provide a graphical user interface (GUI) configured to receive various user inputs and may receive the user input through the GUI. The external device 1410 may update state information of the air conditioner 100 and provide the updated state information through the application, while communicating with the server 1420. Also, the external device 1410 may transmit the user input received through the application to the air conditioner 100 by communicating with the server 1420.

The application may receive a power off signal or an end reservation signal of the air conditioner 100. Also, the application may receive a reservation setting signal and receive a user input for setting an end reservation time. Also, the application may receive a sleep mode-setting signal and receive a user input for setting an end reservation time. Also, the application may receive a user input for setting a noise prevention mode. Also, the application may receive a user input for setting an automatic dry function. Also, the application may receive a user input for setting a windless mode.

The network NET may include both a wired network and a wireless network. The wired network may include a cable network, a telephone network, or the like, and the wireless network may include all networks for transmitting and receiving signals through radio waves. The wired network and the wireless network may be connected to each other.

The network NET may include a WAN, such as the Internet, an LAN established based on an access point (AP), and a wireless personal area network (WPAN) not through the AP. The WPAN may include Bluetooth™ (IEEE 802.15.1), Zigbee (IEEE 802.15.4), WFD, NFC, Z-Wave, etc., but is not limited thereto.

The AP may connect the LAN to which the air conditioner 100 and the external device 1410 are connected to the WAN to which the server 1420 is connected. The air conditioner 100 or the external device 1410 may be connected to the server 1420 through the WAN.

The AP may include a device to connect devices by using related standards using Wi-Fi™ in a computer network.

According to embodiments of the disclosure, the AP may include an AP realized as hardware and an AP realized as software.

For example, the AP may relay data between a wireless device and a wired device on a network. However, the AP is not limited thereto. The AP may relay data between wired devices or relay data between wireless devices. The AP may also be referred to as a relay device.

The AP may communicate with the air conditioner 100 and the external device 1410 through wireless communication, such as Wi-Fi™ (IEEE 802.11), etc., and may access the WAN through wired communication.

The air conditioner 100 may transmit information about an operation or a state to the server 1420 through the network NET. For example, the air conditioner 100 may transmit the information about the operation or the state to the server 1420 through the Wi-Fi™ (IEEE 802.11) communication.

When a Wi-Fi™ communication module is not provided in the air conditioner 100, the air conditioner 100 may transmit the information about the operation or the state to the server 1420 through another home appliance having the Wi-Fi™ communication module. For example, when the air conditioner 100 transmits the information about the operation or the state to the other home appliance through a short-range wireless network (for example, BLE communication), the other home appliance may transmit the information about the operation or the state of the air conditioner 100 to the server 1420. Also, for example, when a Wi-Fi™ communication module is not provided in the air conditioner 100, the air conditioner 100 may be connected to a communication relay device in a wired manner and may perform the 485 communication with the Wi-Fi™ communication through the communication relay device.

The air conditioner 100 may provide the information about the operation or the state of the air conditioner 100 to the server 1420 according to user's prior authorization. The transmission of the information to the server 1420 may be performed when a request is received from the server 1420, may be performed when a certain event occurs in the air conditioner 100, or may be periodically or in real time performed.

When the information about the operation or the state is received from the air conditioner 100, the server 1420 may renew the information pre-stored with respect to the air conditioner 100. The server 1420 may transmit the information about the operation or the state of the air conditioner 100 to the external device 1410 through the network NET.

The server 1420 may transmit the information about the operation or the state of the air conditioner 100 to the external device 1410 when a request is received from the external device 1410. For example, when a user executes, by using the external device 1410, an application connected to the server 1420, the external device 1410 may, through the application, request and receive, from the server 1420, the information about the operation or the state of the air conditioner 100. When the information about the operation or the state is received from the air conditioner 100, the server 1420 may transmit, in real time, the information about the operation or the state of the air conditioner 100 to the external device 1410. The server 1420 may periodically transmit the information about the operation or the state of the air conditioner 100 to the external device 1410. The external device 1410 may transmit the information about the operation or the state of the air conditioner 100 to the user by displaying, on the application execution window, the information about the operation or the state of the air conditioner 100.

The air conditioner 100 may obtain various information from the server 1420 and provide the obtained information to the user. Also, the air conditioner 100 may receive, from the server 1420, pre-installed software or a file for updating data related to the pre-installed software, and based on the received file, may update the pre-installed software or the data related to the pre-installed software.

The air conditioner 100 may operate according to a control command received from the server 1420. For example, when the air conditioner 100 obtains user's pre-authorization to operate according to a control command of the server 1420 even when there is no user input, the air conditioner 100 may operate according to the control command received from the server 1420. The control command received from the server 1420 may include a control command input by the user through the external device 1410, a control command generated by the server 1420 based on a preset condition, etc., but is not limited thereto.

According to an embodiment of the disclosure, the server 1420 may perform at least one of operation S304 or operation S306 of the flowchart of FIG. 3.

According to an embodiment of the disclosure, operation S302 of FIG. 3 may be performed by the air conditioner 100. The air conditioner 100 may obtain a temperature detection value of each of the temperature sensors 110 and may transmit the temperature detection values to the server 1420.

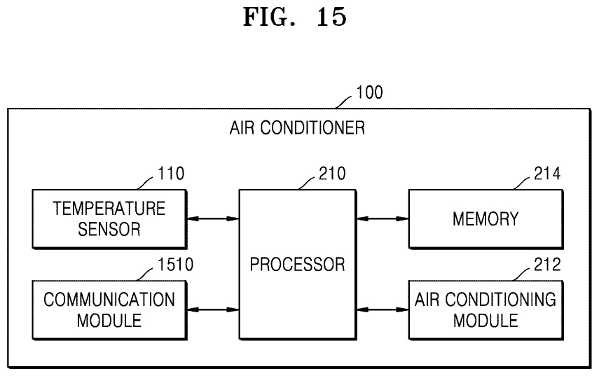

FIG. 15 is a block diagram of a structure of an air conditioner according to an embodiment of the disclosure.

According to an embodiment of the disclosure, the server 1420 may receive the temperature detection values of each of the plurality of temperature sensors 110 from the air conditioner 100 and may perform some of the processes related to the temperature sensor 110 in an abnormal state. For example, the server 1420 may determine whether or not there is the temperature sensor 110 in the abnormal state in the air conditioner 100. Also, when there is the temperature sensor 110 in the abnormal state, the server 1420 may calculate a temperature correction parameter of the temperature sensor 110 in the abnormal state and transmit the temperature correction parameter to the air conditioner 100.

To avoid the description repetition, the same aspects as the air conditioner 100 described with reference to FIG. 2 are not repeatedly described and different aspects from the air conditioner 100 are mainly described.

Referring to FIG. 15, an air conditioner 100 according to an embodiment of the disclosure may include temperature sensors 110, a processor 210, an air conditioning module 212, memory 214, and a communication module 1510.

The communication module 1510 may communicate with other devices with wires or wirelessly. According to an embodiment of the disclosure, the communication module 1510 may wirelessly communicate with a remote controller. The communication module 1510 may receive, from the remote controller, a power on/off signal, a temperature setting signal, an operation mode selection signal, an air blowing intensity selection signal, a sleep reservation signal, a driving reservation setting signal, a wind direction setting signal, etc. The communication module 1510 may transmit state information of the air conditioner 100 to the remote controller in order to be synchronized with the remote controller with respect to the state information of the air conditioner 100.

Also, according to an embodiment of the disclosure, the communication module 1510 may communicate with the server 1420 through a network. The communication module 1510 may access the network through an AP device and may communicate with the server 1420. The communication module 1510 may receive a user input for selecting a user designation mode or a user input for setting an absence schedule from the server 1420. Also, the communication module 1510 may receive, from the server 1420, a power on/off signal, a temperature setting signal, an operation mode selection signal, an air blowing intensity selection signal, a sleep reservation signal, a driving reservation setting signal, a wind direction setting signal, etc. The communication module 1510 may transmit state information of the air conditioner 100 to the server 1420 in order to be synchronized with the server 1420 with respect to the state information of the air conditioner 100. Also, the communication module 1510 may receive, from the server 1420, an operation mode, setting information, etc. of the air conditioner 100 that are set by using a user's terminal, etc.

The communication module 1510 may include a wireless communication module (for example, a cellular communication module, an NFC module, or a global navigation satellite system (GNSS) communication module) or a wired communication module (for example, an LAN communication module or a power line communication module). Also, the communication module 1510 may perform short-range wireless communication and may use, for example, Bluetooth™, BLE, NFC, WLAN (or Wi-Fi™), Zigbee, IrDA communication, WFD, UWB, Ant+ communication, etc. Also, for example, the communication module 1510 may perform remote communication and may communicate with an external device for example through a legacy cellular network, a fifth generation (5G) network, a next-generation communication network, the Internet, a computer network (for example, an LAN or a WAN), or the like.

Also, for example, the communication module 1510 may use mobile communication and may transmit and receive a wireless signal to and from at least one of a base station, an external terminal, or a server on a mobile communication network.

According to an embodiment of the disclosure, the communication module 1510 may be connected to an AP in a household through Wi-Fi™ communication. The communication module 1510 may communicate with other devices through the AP.

The processor 210 may transmit, to the server 1420, the temperature detection value of each of the plurality of temperature sensors 110 through the communication module 1510. When the air conditioner 100 is turned on, the processor 210 may detect the temperature detection value of each of the plurality of temperature sensors 110 before an air conditioning operation is started and may transmit the detected temperature detection values to the server 1420. When the air conditioner 100 transmits the temperature detection value of each of the plurality of temperature sensors 110 to the server 1420, the air conditioner 100 may transmit identification information of each of the temperature sensors 110 with respect to which the temperature detection value is detected. Also, according to an embodiment of the disclosure, the air conditioner 100 may transmit, to the server 1420, separate device information corresponding to each temperature detection value. Also, according to an embodiment of the disclosure, the air conditioner 100 may transmit, to the server 1420, at least one of a time at which each temperature detection value is detected or an operation mode of a time point at which the temperature detection value is detected.

The server 1420 may receive the temperature detection value of each of the plurality of temperature sensors 110 received from the air conditioner 100. The server 1420 may determine whether or not there is the temperature sensor 110 in the abnormal state from among the plurality of temperature sensors 110 by using the received temperature detection value of each of the plurality of temperature sensors 110. The air conditioner 100 may receive a result of determining whether or not there is the temperature sensor 110 in the abnormal state from the server 1420.

Also, when the server 1420 detects the temperature sensor 110 in the abnormal state, the server 1420 may calculate the temperature correction parameter with respect to the temperature sensor 110 in the abnormal state and transmit the calculated temperature correction parameter to the air conditioner 100. The air conditioner 100 may correct the temperature detection value of the temperature sensor 110 in the abnormal state by using the temperature correction parameter received from the server 1420.

According to an embodiment of the disclosure, the air conditioner 100 may not transmit, to the server 1420, the temperature detection value of each of the plurality of temperature sensors 110, after the air conditioner 100 receives the temperature correction parameter. When the air conditioner 100 is turned on again after the air conditioner 100 is subsequently turned off, the air conditioner 100 may transmit the temperature detection value of each of the plurality of temperature sensors 110 to the server 1420.

Also, according to an embodiment of the disclosure, the air conditioner 100 may transmit, to the server 1420, the temperature detection values of one or more temperature sensors 110 from among the plurality of temperature sensors 110 of the air conditioner 100, in order to monitor the state of the air conditioner 100.

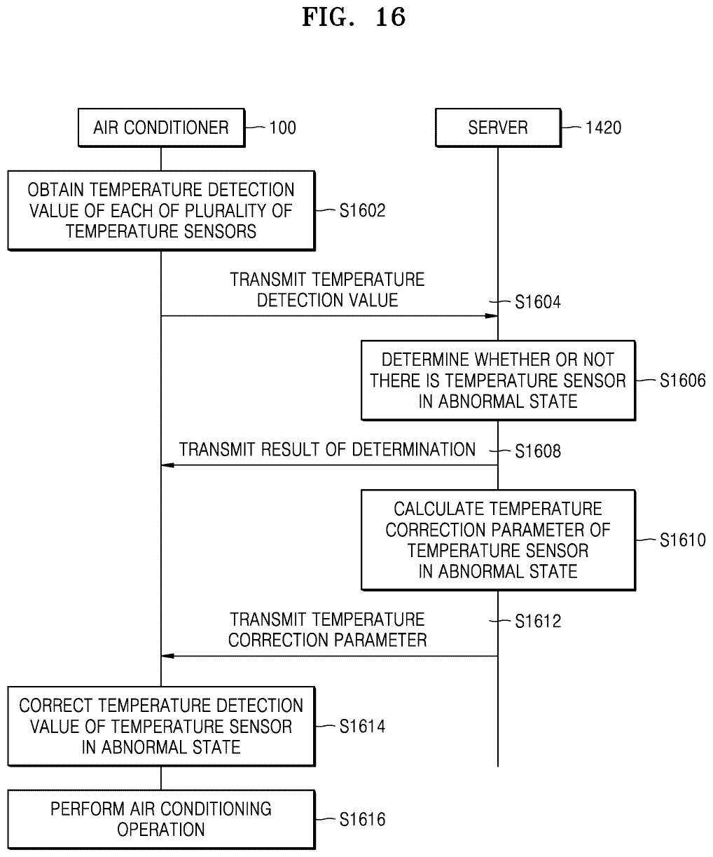

FIG. 16 is a flowchart of a controlling method for an air conditioner, according to an embodiment of the disclosure.

According to an embodiment of the disclosure, the server 1420 may receive the temperature detection value of each of the plurality of temperature sensors 110 from the air conditioner 100 and may perform some of the processes related to the temperature sensor 110 in the abnormal state. For example, the server 1420 may determine whether or not there is the temperature sensor 110 in the abnormal state in the air conditioner 100. Also, when there is the temperature sensor 110 in the abnormal state, the server 1420 may calculate the temperature correction parameter of the temperature sensor 110 in the abnormal state and transmit the calculated temperature correction parameter to the air conditioner 100.

Referring to FIG. 16, an air conditioner 100 may obtain the temperature detection value of each of a plurality of temperature sensors 110 before the air conditioner 100 starts an air conditioning operation, in operation S1602.

Next, in operation S1604, the air conditioner 100 may transmit the temperature detection value of each of the plurality of temperature sensors 110 to a server 1420. When the air conditioner 100 transmits the temperature detection value of each of the plurality of temperature sensors 110 to the server 1420, the air conditioner 100 may transmit identification information of each of the temperature sensors 110 with respect to which the temperature detection value is detected. Also, according to an embodiment of the disclosure, the air conditioner 100 may transmit, to the server 1420, separate device information corresponding to each temperature detection value. Also, according to an embodiment of the disclosure, the air conditioner 100 may transmit, to the server 1420, at least one of a time at which each temperature detection value is detected or an operation mode of a time point at which the temperature detection value is detected. For example, the air conditioner 100 may transmit, to the server 1420, information about whether or not each temperature detection value is detected before the air conditioning operation.

When the server 1420 receives the temperature detection value of each of the plurality of temperature sensors 110, the server 1420 may determine whether or not there is the temperature sensor 110 in the abnormal state, in operation S1606. The server 1420 may determine whether or not there is the temperature sensor 110 in the abnormal state by using the temperature detection values of the plurality of temperature sensors 110 of the same group corresponding to the same separate device. For example, the server 1420 may determine whether or not there is the temperature sensor 110 in the abnormal state in the indoor unit 100a, by using the temperature detection values obtained from the first group of the plurality of temperature sensors 110 arranged in the indoor unit 100a, from among the plurality of temperature detection values. Also, the server 1420 may determine whether or not there is the temperature sensor 110 in the abnormal state in the outdoor unit 100b, by using the temperature detection values obtained from the second group of the plurality of temperature sensors 110 arranged in the outdoor unit 100b.

Next, the server 1420 may transmit, to the air conditioner 100, a result of determining whether or not there is the temperature sensor 110 in the abnormal state, in operation S1608. The server 1420 may transmit the information about whether or not there is the temperature sensor 110 in the abnormal state to the air conditioner 100. Also, when there is the temperature sensor 110 in the abnormal state, the server 1420 may transmit, to the air conditioner 100, identification information of the temperature sensor 110 in the abnormal state.

When there is the temperature sensor 110 in the abnormal state, the server 1420 may calculate the temperature correction parameter of the temperature sensor 110 in the abnormal state, in operation S1610. The temperature correction parameter of the temperature sensor 110 in the abnormal state may be calculated by using the average value of the temperature detection values of the temperature sensors 110 of the same group in a normal state and the temperature detection value of the temperature sensor 110 in the abnormal state, as described above with reference to FIGS. 9 and 10. The server 1420 may transmit the calculated temperature correction parameter to the air conditioner 100, in operation S1612.

When the air conditioner 100 receives the temperature correction parameter, the air conditioner 100 may correct the temperature detection value of the temperature sensor 110 in the abnormal state by using the received temperature correction parameter, in operation S1614. Next, the air conditioner 100 may perform the air conditioning operation by using the temperature detection values of the temperature sensors 110 in the normal state and the corrected temperature detection value of the temperature sensor 110 in the abnormal state, in operation S1616.

According to an embodiment of the disclosure, the server 1420 may generate the normal error by using the temperature detection value of the temperature sensor 110 in the abnormal state, while the air conditioning operation is being performing, as described above with reference to FIG. 11. The server 1420 may receive the temperature detection value of each of the plurality of temperature sensors 110 from the air conditioner 100 while the air conditioning operation is being performed. The server 1420 may determine whether or not the temperature detection value of each of the plurality of temperature sensors 110 changes, by using the temperature detection value of each of the plurality of temperature sensors 110 received from the air conditioner 100. The process of determining whether or not the temperature detection value of each of the plurality of temperature sensors 110 changes may be performed substantially the same as operation S1102 described above. The server 1420 may generate the normal error with respect to the air conditioner 100 when the temperature detection value of each of the plurality of temperature sensors 110 does not change by the third reference value or greater, while the air conditioning operation is being performed. The server 1420 may transmit, to the air conditioner 100, information that the normal error is generated. When the air conditioner 100 receives the information that the normal error is generated, the air conditioner 100 may stop the air conditioning operation.

According to an embodiment of the disclosure, when the temperature sensor 110 in the abnormal state is detected, the server 1420 may output, through the external device 1410, information that the temperature sensor 110 in the abnormal state is detected. The external device 1410 may output, through an application configured to control the air conditioner 100, the information that the temperature sensor 110 in the abnormal state is detected.

Also, when the normal error is generated, the server 1420 may output, through the external device 1410, information that the normal error is generated. Also, the external device 1410 may output, through the application configured to control the air conditioner 100, information that the normal error is generated and the air conditioning operation of the air conditioner 100 is stopped.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment of the disclosure, the method according to various embodiments of the disclosure may be provided as an inclusion of a computer program product. The computer program product may be, as a product, transacted between a seller and a purchaser. The computer program product may be distributed in the form of a machine-readable storage medium (e.g., a CD-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or memory of a relay server, or may be temporarily generated.

According to an aspect of an embodiment of the disclosure, there is provided an air conditioner. The air conditioner includes a first group of a plurality of temperature sensors arranged in a first space, air conditioning module comprising air conditioning circuitry, memory storing one or more computer programs, and one or more processors comprising processing circuitry. The one or more computer programs include computer-executable instructions that, when executed by the one or more processors individually or collectively, cause the air conditioner to obtain a temperature detection value of each of the plurality of temperature sensors of the first group before the air conditioning module starts an air conditioning operation, determine whether there is a temperature sensor in an abnormal state from among the first group of the plurality of temperature sensors by using the temperature detection value of each of the plurality of temperature sensors of the first group, when it is determined that there is the temperature sensor in the abnormal state, correct the temperature detection value of the temperature sensor in the abnormal state to a corrected temperature detection value by using temperature detection values of other temperature sensors which are not in the abnormal state from among the first group of the plurality of temperature sensors, and control the air conditioning operation of the air conditioning module by using the corrected temperature detection value.

Also, according to an aspect of an embodiment of the disclosure, the air conditioner may further include a second group of a plurality of temperature sensors arranged in a second space which is different from the first space. The one or more computer programs further include computer-executable instructions that, when executed by the one or more processors individually or collectively, cause the air conditioner to obtain a temperature detection value of each of the plurality of temperature sensors of the second group before the air conditioning module starts the air conditioning operation, determine whether there is a temperature sensor in the abnormal state from among the second group of the plurality of temperature sensors by using the temperature detection value of each of the plurality of temperature sensors of the second group, and when it is determined that there is a temperature sensor in the abnormal state, correct the temperature detection value of the temperature sensor in the abnormal state to a corrected temperature detection value by using temperature detection values of temperature sensors which are in a normal state from among the second group of the plurality of temperature sensors, wherein the first space and the second space are different spaces corresponding to an indoor unit 100a or an outdoor unit of the air conditioner.

Also, according to an aspect of an embodiment of the disclosure, a time point before the air conditioning module starts the air conditioning operation may correspond to a time point before a compressor operation is started.

Also, according to an aspect of an embodiment of the disclosure, the first group of the plurality of temperature sensors may include three or more temperature sensors. The determining of whether there is the temperature sensor in the abnormal state may include determining, with respect to each of the plurality of temperature sensors of the first group, that a certain temperature sensor is in the abnormal state, if a difference between a temperature detection value of the certain temperature sensor and the temperature detection values of the other temperature sensors of the first group exceeds a first reference value, and a difference between the temperature detection values of the other temperature sensors of the first group is less than a second reference value.

Also, according to an aspect of an embodiment of the disclosure, the one or more computer programs further include computer-executable instructions that, when executed by the one or more processors individually or collectively, cause the air conditioner to obtain the temperature detection value of each of the plurality of temperature sensors of the first group before the air conditioning module starts the air conditioning operation, when power of the air conditioner is turned on, and in response to turning on the power of the air conditioner, obtain the temperature detection value of each of the plurality of temperature sensors of the first group, determine whether there is the temperature sensor in the abnormal state, and correct the temperature detection value of the temperature sensor in the abnormal state.

Also, according to an aspect of an embodiment of the disclosure, the first space may correspond to a space in or around the indoor units of the air conditioner. The first group of the plurality of temperature sensors may include three or more temperature sensors from among a room temperature sensor, an evaporator inlet temperature sensor, an evaporator outlet temperature sensor, and an outlet temperature sensor.

Also, according to an aspect of an embodiment of the disclosure, the first space may correspond to a space in or around an outdoor unit of the air conditioner. The first group of the plurality of temperature sensors may include three or more temperature sensors from among a room temperature sensor, a compressor outlet temperature sensor, a compressor top temperature sensor, and a condenser outlet temperature sensor.

Also, according to an aspect of an embodiment of the disclosure, the one or more computer programs further include computer-executable instructions that, when executed by the one or more processors individually or collectively, cause the air conditioner to when it is determined that there is the temperature sensor in the abnormal state, calculate an average of the temperature detection values of the other temperature sensors of the first group except for the temperature sensor in the abnormal state, and correct the temperature detection value of the temperature sensor in the abnormal state to the corrected temperature detection value by using a difference value between the temperature detection value of the temperature sensor in the abnormal state and the average of the temperature detection values of the other temperature sensors of the first group.

Also, according to an aspect of an embodiment of the disclosure, the one or more computer programs further include computer-executable instructions that, when executed by the one or more processors individually or collectively, cause the air conditioner to when there is at least one temperature sensor from which the temperature detection value is not output, generate a normal error and stop the air conditioning operation, while the normal error is not being generated, obtain the temperature detection value of each of the plurality of temperature sensors of the first group before the air conditioning module starts the air conditioning operation, and when there is the temperature sensor in the abnormal state, generate a hidden error and perform the air conditioning operation by using the corrected temperature detection value of the temperature sensor in the abnormal state.

Also, according to an aspect of an embodiment of the disclosure, the one or more computer programs further include computer-executable instructions that, when executed by the one or more processors individually or collectively, cause the air conditioner to store the hidden error as hidden error information. Also, The hidden error information may include at least one of identification information of the temperature sensor in the abnormal state, a pattern of the temperature detection value, a temperature correction parameter, or a date and time when the hidden error was generated. Also, by storing the hidden error information, the air conditioner may allow a user to subsequently refer to the hidden error information.

Also, according to an aspect of an embodiment of the disclosure, the normal error is generated based on at least one of a first case in which a short circuit or an open circuit occurs in at least one internal circuit from among the first group of the plurality of temperature sensors or a second case in which at least one connector is released from among the first group of the plurality of temperature sensors.

Also, according to an aspect of an embodiment of the disclosure, the one or more computer programs further include computer-executable instructions that, when executed by the one or more processors individually or collectively, cause the air conditioner to after the air conditioning operation has started, generate the normal error when the temperature detection value of the temperature sensor in the abnormal state does not change during a reference time period, and when a change of the temperature detection value of the temperature sensor in the abnormal state is detected, generate the hidden error and correct the temperature detection value of the temperature sensor in the abnormal state to the corrected temperature detection value by using a difference value between the temperature detection value of the temperature sensor in the abnormal state and an average of the temperature detection values of the other temperature sensors of the first group.

Also, according to an aspect of an embodiment of the disclosure, the air conditioner may further include communication circuitry, and the one or more computer programs further include computer-executable instructions that, when executed by the one or more processors individually or collectively, cause the air conditioner to transmit, through the communication circuitry to a server, the temperature detection value of each of the plurality of temperature sensors of the first group before the air conditioning module starts the air conditioning operation, receive, from the server, a result of determining whether there is the temperature sensor in the abnormal state from among the first group of the plurality of temperature sensors, and receive, from the server, a temperature correction parameter for correcting the temperature detection value of the temperature sensor in the abnormal state.

Also, according to an aspect of an embodiment of the disclosure, the air conditioner may include a plurality of indoor units and an outdoor unit, and the plurality of indoor units may be defined as being in different spaces from each other.

Also, according to an aspect of an embodiment of the disclosure, there is provided a controlling method performed by an air conditioner including temperature sensors. The controlling method includes before air conditioning module of the air conditioner starts an air conditioning operation, obtaining, by the air conditioner, a temperature detection value of each of a first group of the plurality of temperature sensors arranged in a first space, determining, by the air conditioner, whether there is a temperature sensor in an abnormal state from among the first group of the plurality of temperature sensors by using the temperature detection value of each of the plurality of temperature sensors of the first group, based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors, and performing, by the air conditioner, the air conditioning operation by using the corrected temperature detection value.

Also, according to an aspect of an embodiment of the disclosure, the air conditioner may include a second group of the plurality of temperature sensors arranged in a second space different from the first space. The controlling method further includes obtaining, by the air conditioner, a temperature detection value of each of the plurality of temperature sensors of the second group before the air conditioning module starts the air conditioning operation, determining, by the air conditioner, whether there is a temperature sensor in an abnormal state from among the second group of the plurality of temperature sensors by using the temperature detection value of each of the plurality of temperature sensors of the second group, and, based on determining that there is the temperature sensor in the abnormal state, correcting, by the air conditioner, the temperature detection value of the temperature sensor in the abnormal state by using temperature detection values of temperature sensors in a normal state from among the second group of the plurality of temperature sensors. The first space and the second space may be different spaces corresponding to an indoor unit or an outdoor unit of the air conditioner.

Also, according to an aspect of an embodiment of the disclosure, a time point before the air conditioning module starts the air conditioning operation may correspond to a time point before a compressor operation is started.

Also, according to an aspect of an embodiment of the disclosure, the first group of the plurality of temperature sensors may include three or more temperature sensors. The determining of whether there is the temperature sensor in the abnormal state may include determining, by the air conditioner with respect to each of the plurality of temperature sensors of the first group, that a certain temperature sensor is in the abnormal state, based on a difference between a temperature detection value of the certain temperature sensor and the temperature detection values of the other temperature sensors of the first group exceeding a first reference value and a difference between the temperature detection values of the other temperature sensors of the first group being less than a second reference value.

Also, according to an aspect of an embodiment of the disclosure, the obtaining of the temperature detection value of each of the plurality of temperature sensors of the first group may include obtaining, by the air conditioner, the temperature detection value of each of the plurality of temperature sensors of the first group before the air conditioning module starts the air conditioning operation, in response to turning on power of the air conditioner. The controlling method further includes, in response to turning on the power of the air conditioner, obtaining, by the air conditioner, the temperature detection value of each of the plurality of temperature sensors of the first group, determining, by the air conditioner, whether there is the temperature sensor in the abnormal state, and correcting, by the air conditioner, the temperature detection value of the temperature sensor in the abnormal state.

Also, according to an aspect of an embodiment of the disclosure, the correcting of the temperature detection value of the temperature sensor in the abnormal state may include calculating, by the air conditioner, an average of the temperature detection values of the other temperature sensors of the first group except for the temperature sensor in the abnormal state, and correcting, by the air conditioner, the temperature detection value of the temperature sensor in the abnormal state to the corrected temperature detection value by using a difference value between the temperature detection value of the temperature sensor in the abnormal state and the average of the temperature detection values of the other temperature sensors of the first group.

Also, according to an aspect of an embodiment of the disclosure, the method further comprises, in response to turning on the air conditioner, determining, by the air conditioner, to perform the operation of detecting the temperature sensor in the abnormal state by using the temperature detection value of each of the plurality of temperature sensors of the first group, in response to a reference time period or longer passing from a last time point at which the air conditioner was turned off.

Also, according to an aspect of an embodiment of the disclosure, there is provided one or more non-transitory computer-readable storage media storing one or more computer programs including computer-executable instructions that, when executed by the one or more processors of an air conditioner individually or collectively, cause the air conditioner to perform operations. The operations including, before air conditioning module of the air conditioner starts an air conditioning operation, obtaining, by the air conditioner, a temperature detection value of each of a first group of a plurality of temperature sensors arranged in a first space, determining, by the air conditioner, whether there is a temperature sensor in an abnormal state from among the first group of the plurality of temperature sensors by using the temperature detection value of each of the plurality of temperature sensors of the first group, based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors, and performing, by the air conditioner, the air conditioning operation by using the corrected temperature detection value.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An air conditioner comprising:
a first group of a plurality of temperature sensors arranged in a first space;
an air conditioning module comprising air conditioning circuitry;
memory storing one or more computer programs; and
one or more processors comprising processing circuitry, configured to execute the one or more computer programs,
wherein the one or more computer programs include computer-executable instructions that, when executed by the one or more processors individually or collectively, cause the air conditioner to:
obtain a temperature detection value of each of the plurality of temperature sensors of the first group before the air conditioning module starts an air conditioning operation,
determine whether there is a temperature sensor in an abnormal state from among the first group of the plurality of temperature sensors by using the temperature detection value of each of the plurality of temperature sensors of the first group,
when it is determined that there is the temperature sensor in the abnormal state, correct the temperature detection value of the temperature sensor in the abnormal state to a corrected temperature detection value by using temperature detection values of other temperature sensors not in the abnormal state from among the first group of the plurality of temperature sensors, and
control the air conditioning operation of the air conditioning module by using the corrected temperature detection value.

2. The air conditioner of claim 1, further comprising:
a second group of a plurality of temperature sensors arranged in a second space different from the first space,
wherein the one or more computer programs further include computer-executable instructions that, when executed by the one or more processors individually or collectively, cause the air conditioner to:
obtain a temperature detection value of each of the plurality of temperature sensors of the second group before the air conditioning module starts the air conditioning operation,
determine whether there is a temperature sensor in the abnormal state from among the second group of the plurality of temperature sensors by using the temperature detection value of each of the plurality of temperature sensors of the second group, and
when it is determined that there is the temperature sensor in the abnormal state, correct the temperature detection value of the temperature sensor in the abnormal state to a corrected temperature detection value by using temperature detection values of temperature sensors in a normal state from among the second group of the plurality of temperature sensors, and
wherein the first space and the second space are different spaces corresponding to an indoor unit or an outdoor unit of the air conditioner.

3. The air conditioner of claim 1, wherein a time point before the air conditioning module starts the air conditioning operation corresponds to a time point before a compressor operation is started.

4. The air conditioner of claim 1,
wherein the first group of the plurality of temperature sensors comprises three or more temperature sensors, and
wherein the determining of whether there is the temperature sensor in the abnormal state comprises determining, with respect to each of the plurality of temperature sensors of the first group, that a certain temperature sensor is in the abnormal state if a difference between a temperature detection value of the certain temperature sensor and the temperature detection values of the other temperature sensors of the first group exceeds a first reference value and a difference between the temperature detection values of the other temperature sensors of the first group is less than a second reference value.

5. The air conditioner of claim 1, wherein the one or more computer programs further include computer-executable instructions that, when executed by the one or more processors individually or collectively, cause the air conditioner to:
obtain the temperature detection value of each of the plurality of temperature sensors of the first group before the air conditioning module starts the air conditioning operation, when power of the air conditioner is turned on, and
in response to turning on the power of the air conditioner, obtain the temperature detection value of each of the plurality of temperature sensors of the first group, determine whether there is the temperature sensor in the abnormal state, and correct the temperature detection value of the temperature sensor in the abnormal state.

6. The air conditioner of claim 1,
wherein the first space corresponds to a space in or around indoor units of the air conditioner, and
wherein the first group of the plurality of temperature sensors comprises three or more temperature sensors from among a room temperature sensor, an evaporator inlet temperature sensor, an evaporator outlet temperature sensor, and an outlet temperature sensor.

7. The air conditioner of claim 1,
wherein the first space corresponds to a space in or around an outdoor unit of the air conditioner, and
wherein the first group of the plurality of temperature sensors comprises three or more temperature sensors from among a room temperature sensor, a compressor outlet temperature sensor, a compressor top temperature sensor, and a condenser outlet temperature sensor.

8. The air conditioner of claim 1, wherein the one or more computer programs further include computer-executable instructions that, when executed by the one or more processors individually or collectively, cause the air conditioner to:
when it is determined that there is the temperature sensor in the abnormal state, calculate an average of the temperature detection values of the other temperature sensors of the first group except for the temperature sensor in the abnormal state, and
correct the temperature detection value of the temperature sensor in the abnormal state to the corrected temperature detection value by using a difference value between the temperature detection value of the temperature sensor in the abnormal state and the average of the temperature detection values of the other temperature sensors of the first group.

9. The air conditioner of claim 1, wherein the one or more computer programs further include computer-executable instructions that, when executed by the one or more processors individually or collectively, cause the air conditioner to:
when there is at least one temperature sensor from which the temperature detection value is not output, generate a normal error and stop the air conditioning operation,
while the normal error is not being generated, obtain the temperature detection value of each of the plurality of temperature sensors of the first group before the air conditioning module starts the air conditioning operation, and
when there is the temperature sensor in the abnormal state, generate a hidden error and perform the air conditioning operation by using the corrected temperature detection value of the temperature sensor in the abnormal state.

10. The air conditioner of claim 9,
wherein the one or more computer programs further include computer-executable instructions that, when executed by the one or more processors individually or collectively, cause the air conditioner to:
store the hidden error as hidden error information,
wherein the hidden error information includes at least one of identification information of the temperature sensor in the abnormal state, a pattern of the temperature detection value, a temperature correction parameter, or a date and time when the hidden error was generated, and
wherein, by storing the hidden error information, the air conditioner allow a user to subsequently refer to the hidden error information.

11. The air conditioner of claim 9, wherein the normal error is generated based on at least one of a first case in which a short circuit or an open circuit occurs in at least one internal circuit from among the first group of the plurality of temperature sensors or a second case in which at least one connector is released from among the first group of the plurality of temperature sensors.

12. The air conditioner of claim 9, wherein the one or more computer programs further include computer-executable instructions that, when executed by the one or more processors individually or collectively, cause the air conditioner to:
after the air conditioning operation has started, generate the normal error when the temperature detection value of the temperature sensor in the abnormal state does not change during a reference time period, and
when a change of the temperature detection value of the temperature sensor in the abnormal state is detected, generate the hidden error and correct the temperature detection value of the temperature sensor in the abnormal state to the corrected temperature detection value by using a difference value between the temperature detection value of the temperature sensor in the abnormal state and an average of the temperature detection values of the other temperature sensors of the first group.

13. The air conditioner of claim 1, further comprising:
communication circuitry,
wherein the one or more computer programs further include computer-executable instructions that, when executed by the one or more processors individually or collectively, cause the air conditioner to:
transmit, through the communication circuitry to a server, the temperature detection value of each of the plurality of temperature sensors of the first group before the air conditioning module starts the air conditioning operation,
receive, from the server, a result of determining of whether there is the temperature sensor in the abnormal state from among the first group of the plurality of temperature sensors, and
receive, from the server, a temperature correction parameter for correcting the temperature detection value of the temperature sensor in the abnormal state.

14. The air conditioner of claim 1,
wherein the air conditioner comprises a plurality of indoor units and an outdoor unit, and
wherein the plurality of indoor units are defined as being in different spaces from each other.

15. A controlling method performed by an air conditioner comprising temperature sensors, the controlling method comprising:
before air conditioning module of the air conditioner starts an air conditioning operation, obtaining, by the air conditioner, a temperature detection value of each of a first group of a plurality of temperature sensors arranged in a first space;
determining, by the air conditioner, whether there is a temperature sensor in an abnormal state from among the first group of the plurality of temperature sensors by using the temperature detection value of each of the plurality of temperature sensors of the first group;
based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors; and
performing, by the air conditioner, the air conditioning operation by using the corrected temperature detection value.

16. The controlling method of claim 15,
wherein the air conditioner comprises a second group of the plurality of temperature sensors arranged in a second space different from the first space,
wherein the controlling method further comprises:
obtaining, by the air conditioner, a temperature detection value of each of the plurality of temperature sensors of the second group before the air conditioning module starts the air conditioning operation;
determining, by the air conditioner, whether there is a temperature sensor in an abnormal state from among the second group of the plurality of temperature sensors by using the temperature detection value of each of the plurality of temperature sensors of the second group; and
based on determining that there is the temperature sensor in the abnormal state, correcting, by the air conditioner, the temperature detection value of the temperature sensor in the abnormal state by using temperature detection values of temperature sensors in a normal state from among the second group of the plurality of temperature sensors, and
wherein the first space and the second space are different spaces corresponding to an indoor unit or an outdoor unit of the air conditioner.

17. The controlling method of claim 15, wherein a time point before the air conditioning module starts the air conditioning operation corresponds to a time point before a compressor operation is started.

18. The controlling method of claim 15,
wherein the first group of the plurality of temperature sensors comprises three or more temperature sensors, and
wherein the determining of whether there is the temperature sensor in the abnormal state comprises determining, by the air conditioner with respect to each of the plurality of temperature sensors of the first group, that a certain temperature sensor is in the abnormal state, based on a difference between a temperature detection value of the certain temperature sensor and the temperature detection values of the other temperature sensors of the first group exceeding a first reference value and a difference between the temperature detection values of the other temperature sensors of the first group being less than a second reference value.

19. The controlling method of claim 15, further comprising:
in response to turning on the air conditioner, determining, by the air conditioner, to perform the operation of detecting the temperature sensor in the abnormal state by using the temperature detection value of each of the plurality of temperature sensors of the first group, in response to a reference time period or longer passing from a last time point at which the air conditioner was turned off.

20. One or more non-transitory computer-readable storage media storing one or more computer programs including computer-executable instructions that, when executed by one or more processors of an air conditioner individually or collectively, cause the air conditioner to perform operations, the operations comprising:
before air conditioning module of the air conditioner starts an air conditioning operation, obtaining, by the air conditioner, a temperature detection value of each of a first group of a plurality of temperature sensors arranged in a first space;
determining, by the air conditioner, whether there is a temperature sensor in an abnormal state from among the first group of the plurality of temperature sensors by using the temperature detection value of each of the plurality of temperature sensors of the first group;
based on determining that there is the temperature sensor in the abnormal state, correcting, by the air conditioner, the temperature detection value of the temperature sensor in the abnormal state to a corrected temperature detection value by using temperature detection values of temperature sensors not in the abnormal state from among the first group of the plurality of temperature sensors; and
performing, by the air conditioner, the air conditioning operation by using the corrected temperature detection value.
